(19) United States
(12) Patent Application Publication
(10) Pub. No.: US 2025/0285558 A1
(43) Pub. Date: Sep. 11, 2025

(54) ATTRIBUTE CORRELATION BASED MULTIPLICATION AND DIVISION SYSTEM AND METHOD

(71) Applicant: Alejandro Enrique QUINONES SATTLER, Ottawa (CA)

(72) Inventor: Alejandro Enrique QUINONES SATTLER, Ottawa (CA)

(21) Appl. No.: 19/219,218

(22) Filed: May 27, 2025

Related U.S. Application Data
(63) Continuation-in-part of application No. 16/767,672, filed on May 28, 2020, now abandoned.

(51) Int. Cl. G09B 23/02

(52) U.S. Cl. CPC G09B 23/02

(57) ABSTRACT

A grid and sheet system and method are provided for teaching multiplication using numerals ranging from “3” to “12” comprising a set of non-numerical representations, in on one or more fixed media formats. Each representation is distinguishable on the basis of one or more attributes, one attribute being colour, to provide factor, factor operation and solution representations. An attribute of each factor representation can be manipulated by a learner using a colour mixing operation to derive a colour attribute of the factor operation representation. Said colour attribute of the factor representation may be incorporated into the solution representation which encodes and embeds the solution of the factor operation. The shared colour attribute between the factor operation representation and solution representation allows the solution decoded or discovered from the solution representation to be readily correlated to the factor operation representation and accordingly recognized as the solution (product) to the factor operation.

### CROSS-REFERENCE TO RELATED APPLICATIONS

The present application is a continuation-in-part of U.S. application Ser. No. 16/767,672 titled “Attribute Correlation Based Multiplication and Division System and Method,” filed on May 28, 2020, which is a national stage application of Int'l App. No. PCT/CA2018/051499 with the same title, filed on Nov. 26, 2018, which claims priority to U.S. Prov. App. No. 62/591,547, filed on Nov. 28, 2017, all of which are incorporated by reference in their entireties.

### FIELD OF THE INVENTION

The present invention relates to the field of systems methods for teaching and learning multiplication and division using numerals ranging from “3” to “12”.

### BACKGROUND OF THE INVENTION

The background to the invention provides information about the state of the art relating to methods and systems for teaching and learning the multiplication and division for numerals up to “12” as factors in simple, two-factor equations.

Many methods and devices have been developed to try to help children and other learners master the fundamentals of multiplication and division. Each of these has its limitations in terms of how effective they are for a wide demographic of learners.

A method is disclosed in U.S. Pat. No. 4,583,952 issued in the name of Evelyn De la Paz Rios wherein there is shown and described a “Method for Teaching Multiplication and Division with Numbers 6 through 9”. The De La Paz Rios method uses both hands, without any additional apparatus and requires from the students a mastery of multiplication for the numbers “1” through “5” and “10” to solve problems in multiplication and division involving the numbers “6” through “9”. This approach has limited capabilities to engage a wide demographic of learners with different learning styles and strengths.

Another method is disclosed in U.S. Pat. No. 6,155,836 issued in the name of Tapp Hancock, wherein there is shown and described a system for teaching mathematics using gloves and/or finger puppets with the digits representing non-sequential number series (e.g., two, four, six, etc.) Hancock's system to teach multiplication requires the mastering of the counting of a non-sequential numerical series (e.g., multiplication by six, for the numerical series “6”, “12”, “18”, 24”, etc.), and so on for each factor and the student takes on a largely receptive role again with limited opportunity for learners to be an active agent in the learning process.

U.S. Pat. No. 7,077,654 issued in the name of Jo Ann Burtness discloses a visual method of teaching arithmetic, in which graphical representations of familiar objects are used instead of numbers, for children who are visually oriented and have difficulty with numbers. The shapes of the objects resemble the numerals zero through nine. The objects may appear in any visual medium. Students are first shown examples of multiplication, division, addition, and subtraction, in which objects replace numbers. Each object is then shown by itself. The numeral that corresponds to the number value of each object is then overlaid on top of each object. Students are also shown groups of colored dots or balls, in which the colors of the dots match the colors of the objects and the number of dots corresponds to the numerical value represented by its corresponding object. This approach is focused entirely on reinforcing the visual recognition of individual numerals by consistently using the same non-numerical representations for a given numeral throughout the application of the method. While this approach provides for reinforced numeral recognition, it is not well adapted to provide factor operation, problem solving skill development.

U.S. Pat. No. 7,223,102 issued in the name of Larissa Powell discloses a system and method for teaching basic mathematical operations and facts; and more particularly an apparatus for the development of accurate and consistent conceptual models for learning certain math facts for the first time, wherein every digit of any number gets a consistent name. The name can be weaved into a story and rhyme throughout the learning process in both the math questions and in the math answers. For the learner, the consistent “name for a digit” approach that is disclosed provides some limited problem solving skill development, however, it is complex and cumbersome for learners who have difficulties learning or generating stories and phrases to associate non-numerical equation phrases to solution phrases and then decode the numerical counterparts from theses phrases.

It would be desirable to have relatively simple systems and methods that help learners master the multiplication and division for number values from “3” to “12”, wherein such methods are predicated on learners having already mastered the multiplication of the number values 5 (facts they learn from telling time) and 10 (very obvious and easy to learn). Such systems and methods can engage learners to be active agents in their learning by promoting the application multiple and preferred cognitive pathways, such as the use of physical movement, visual cues and other sensory capabilities.

Therefore, there currently exists a need in the industry for teaching and learning systems and methods that arouse curiosity and interest according to the needs and preferences of learners, with an underlying consistent approach for mastering with confidence the multiplication and division of operations using factors “3” to “12”, in a manner that is fun and easy-to-implement, and that may be deployed to promote active learner participation/engagement (e.g. physical movement).

### SUMMARY OF THE INVENTION

The present invention relates generally to systems and methods that engage students to learn multiplication and division using multiple cognitive and sensory processing pathways. The methods and systems disclosed herein are adaptable to the optimal processing pathways of learners and support the development of multiple cognitive skill sets such as recognition, correlation, derivation and decoding skill sets, to name a few. It is an object of the present disclosure to provide easy to apply methods and systems, which provide distinct non-numerical representations for: (i) numerical factors ranging from “3” to “12”; (ii) factor operations comprising said factors; and (iii) the solutions to the factor operations, wherein each non-numerical representation comprises one or more attributes that can be systematically associated with the numerical factors, factor operations and their solutions, respectively.

Unlike the prior art, rather than focusing on the consistent representation of individual numerals, the (non-numerical) representations are selected to facilitate the development of problem solving skill sets where leaners must derive, using a (specified) non-numerical operation, a distinct factor operation representation, wherein the factor operation representation is not a mere accumulation or compilation of the attributes of the factor representations. This is followed by a decoding step applied to the solution representation to determine the numerical solution to a given factor operation. A shared attribute can be used to correlate the solution representation to the factor operation representation and thereby allow learners to track solutions back to the subject factor operations. To further reinforce the development of problem solving and correlation skill sets, the shared attribute between the factor operation representation and solution representation may be the same attribute derived by performing the (specified) non-numerical operation using attributes of the factor representation.

In an aspect there is provided a system of learning aids for teaching or learning multiplication and division, comprising sensible non-numerical representations of numerals and numerical operations fixed on media, each representation being distinguishable one from the other by one or more attributes, one being colour, and corresponding to one of a factor in a factor operation to provide one or more factor representations, a factor operation to provide a factor operation representation, and a solution to the factor operation to provide a solution representation, wherein the factor operation representation is derivable by performing a non-numerical (e.g. colour mixing) operation using one or more of the one or more attributes of the one or more factor representations, and the solution representation comprises a shared attribute (e.g. the colour obtained by performing the colour mixing operation) with the factor operation representation.

In a further aspect there is provided a kit or set of sensible, non-numerical representations of numerals and numerical operations fixed on media, each representation being distinguishable one from the other by one or more attributes, one being colour, and corresponding to one of a factor in a factor operation to provide one or more factor representations, a factor operation to provide a factor operation representation, and a solution to the factor operation to provide a solution representation, wherein the factor operation representation is derivable by performing a non-numerical (e.g. colour mixing) operation using one or more of the one or more attributes of the one or more factor representations, and the solution representation comprises a shared attribute (e.g. the colour obtained by performing the colour mixing operation) with the factor operation representation

In another aspect there is provided a multi-piece semi-circle and track set of learning aids for discovering the solution of a multiplication operation comprising: a) a first piece provided in a physical or a digital format comprising a multi-layered first piece with a numbered track portion and a first piece semi-circular portion, displaying in segments of a first outermost layer of said portion from left to right, a series of products each corresponding to a solution of a two factor operation consisting of factors selected from the numerals 6 to 9 and a numbered track portion under the first piece semi-circular portion displaying the numerals 3 to 12; b) a second piece provided in a physical or a digital format comprising a multi-layered second piece semi-circular portion, displaying, in segments of a second outermost layer of said portion from left to right, an array of colours, and, in segments of an inner layer immediately under the second outermost layer from left to right, a series of solution representations each comprising the colour above it in the second outermost layer, wherein when the second piece is overlaid over the first piece the array of colours displayed in the second outermost layer covers the series of products displayed in the first outermost layer; c) a third piece provided in a physical or a digital format comprising a multi-layered third piece semi-circular portion, displaying, in segments of a third outermost layer of said portion from left to right, the same array of colours as the array of colours displayed in the second outermost layer and, in segments of an inner layer immediately under the third outermost layer form left to right, a series of two factor operations consisting of factors selected from the numerals 6 to 9, wherein the colour above each two factor operation is a factor operation representation colour and the same colour displayed in the second outermost layer of the second piece that covers the product displayed in the first outermost layer, such that when the third piece is overlaid over the second piece, the array of colours displayed in the third outermost layer covers the series of solution representations displayed in the inner layer of the second piece; and d) a fourth piece provided in a physical or a digital format comprising a multi-layered fourth piece semi-circular portion, displaying, in segments of a third outermost layer of said portion from left to right, the same array of colours as the array of colours displayed in the third outermost layer and in the second outermost layer, wherein when the fourth piece is overlaid over the third piece, the array of colours in the fourth outermost layer covers the series of factor operations displayed in the inner layer of the third piece; wherein overlaying the second piece over the first piece, the third piece over the second piece and the fourth piece over the third piece provides an assembled multi-piece semi-circle and track tool combining the semi-circular portions of each of said pieces to provide an array of combined segments each including the alignment of like coloured segments displayed in each of the second, third and fourth outermost layers, respectively, for a user to disassemble and discover the solution of a user-selected two factor operation consisting of factors selected from the numerals 6 to 9.

In a further aspect there is provided a method of solving a multiplication operation comprising the steps of: a) providing a set of learning aids for the assembly and disassembly of a multi-piece semi-circle and track tool; b) assembling the set of learning aids to provide the multi-piece semi-circle and track tool; c) selecting a combined coloured segment from the combined semi-circular portions of multi-piece semi-circle and track tool to select a factor operation representation colour; d) removing the fourth piece from on top of the third piece to reveal the user-selected two factor operation displayed in the inner layer of the third piece under the selected factor operation representation colour displayed in the fourth outermost layer of the fourth piece, in the same combined segment of the tool; e) removing the third piece from on top of the second piece to reveal the solution representation displayed in the inner layer of the second piece under the selected factor operation representation colour displayed in the third outermost layer of the third piece, in the same combined segment also containing the user-selected two factor operation revealed in step (d); and f) removing the second piece from on top of the first piece to reveal the product of the user-selected two factor operation displayed in the first outermost layer of the first piece under the selected factor operation representation colour displayed in the second outermost layer of the second piece, in same combined segment of the tool also containing the user-selected two factor operation revealed in step (d) and the solution representation revealed in step (e).

In yet another aspect there is provided a kit for a user to solve a multiplication operation comprising learning aids for the assembly and disassembly of a multi-piece semi-circle and track tool. In still a further aspect there is provided a kit comprising one or more sets of learning aids selected from a set of learning aids for the assembly and disassembly of a multi-piece semi-circle and track tool, a colour mixed reference tool, one or more sets of manipulative grouping learning aids, one or more sets of representative learning aids and one or more sets of visually (visual) reinforcing learning aids.

In another aspect there is provided a set of manipulative grouping learning aids comprising tools for solving a user-selected two factor operation consisting of factors selected from the numerals 6 to 9, including: i) a coloured quadrilateral grid sheet with squares totaling in number to the solution of the user-selected two factor operation, wherein the quadrilateral sheet has the same colour as a pre-assigned factor operation representation colour for the user-selected factor operation; ii) two factor bars, each with a number of squares corresponding to a numeric factor of the user-selected factor operation, wherein each of the bars is coloured in a primary, pre-assigned factor representation colour for the respective numeric factor of the user-selected factor operation, and a group of five-square pieces coloured in a non-primary colour, wherein when the group of pieces is overlaid on top of the quadrilateral grid sheet, the user can discover an equation of the general expression “5×+y” to solve and discover the solution to the user-selected factor operation.

In yet another aspect there is provided a set of representative learning aids comprising tools for solving a user-selected two factor operation consisting of factors selected from the numerals 6 to 9, including: i) a coloured foldable grid sheet with squares totaling in number to the solution of the user-selected two factor operation, a foldable edge for folding and unfolding one or more right side columns and a foldable edge for folding and unfolding one or more partial, top end rows of the foldable grid sheet, wherein the foldable grid sheet has the same colour as a pre-assigned factor operation representation colour for the user-selected factor operation; ii) a question grid mat with ‘x’ and ‘y’ axes each numbered from 1 to 10 and onto which the foldable grid sheet can be placed and manipulated along the foldable edges of said sheet for the user to the discover an equation of the general expression “5×+y” to solve the solution to the user-selected factor operation; and iii) an answer grid mat with a ‘x’ axis numbered in increments of 5 from 5 to 45 and a ‘y’ axis with numbered in increments of 10 from 50 to 100, wherein when the one or more right side columns are unfolded and the one more partial, top end rows are folded, and the foldable grid sheet is then placed onto the answer mat, the user can discover the solution to the equation and the solution to user-selected factor operation.

In still another aspect there is provided a set of visually (visual) reinforcing learning aids comprising tools for discovering a numeric solution of a user-selected two factor operation consisting of factors selected from the numerals 6 to 9, including: i) sheet displaying imagery of a solution representation of the user-selected factor operation with a first outline of the numeric solution embedded in the imagery of the solution representation; and ii) a transparent laminate revealing the numeric solution as a second outline of a numeric solution printed and displayed thereon, wherein when the laminate is overlaid over the sheet displaying the imagery of the solution representation, the outline of the numeric solution on the laminate overlays the outline of the numeric solution embedded in the imagery of the solution representation to provide a superimposed, combined image of the first and second outlines of the numeric solutions

In embodiments different sets of learning aides and other tools (e.g. a colour mixed reference tool) are combined with one another and provided in a kit format. The sets of learning aids and kits of the present disclosure, may be packaged, stored, and sorted for ease of use by a learner (user) by providing boards and/or cases with delineated areas and compartments.

### BRIEF DESCRIPTION OF THE DRAWINGS

These and other features of the invention will become more apparent in the following detailed description in which reference is made to the appended drawings/figures as briefly described below.

FIG. 1: An exemplary set of distinguishable factor representations applied to a set of factors, the numerals “6”, “7”, “8” and “9”, with distinguishable colour attributes, selected from the colours yellow, red and blue, and white, respectively.

FIG. 2: Is an exemplary representation of a set of factor operation representations derived by applying a non-numerical operation using the colour attributes of two factor representations corresponding to the numerals of a factor operation.

FIG. 3: An exemplary (overlapping circle) format for deriving a factor operation representation obtained by mixing (blending) the colour attributes of factor representations.

FIG. 4: An exemplary (crashing car) format for deriving a factor operation representation obtained by mixing (blending) the colour attributes of factor representations.

FIG. 5: An exemplary factor operation format for deriving a factor operation representation obtained by mixing (blending) the colour attributes of factor representations.

FIG. 6: An exemplary set of solution representations encoding numerical solutions to factor operations, each sharing a colour attribute in common with a corresponding factor operation representation, as part of an image (with several attributes), whose name (attribute) rhymes with the name of the numerical solution.

FIG. 7: The exemplary set of solution representations of FIG. 6, with instructions for decoding from said solution representations the numerical solutions of the original (subject) multiplication factor operations corresponding to the related factor operation representations.

FIG. 8: A consolidated set of instructions and method steps for decoding a solution representation (entitled “GREEN Skate”) from FIGS. 6 and 7.

FIG. 9: A learning tool fixed onto a medium, such as a mat, for use in delivering a visual and kinesthetic system and method for the multiplication and division of two-factor operations comprising the factor numerals three to twelve, as further described in Example 2.

FIG. 10: A learning tool comprising a combination of two teaching/learning systems fixed onto a medium, such as a mat for delivering visual and/or kinesthetic systems and methods for the multiplication and division of two-factor operations comprising the factor numerals three to twelve, as further described in Example 2.

FIG. 11: An exemplary die design for use in embodiments of the system and method of the present disclosure for working with the factors “6”, “7”, “8” and “9” as well as factors “5” and “10”. The numerals/factors “6”, “7”, “8” and “9” are presented on a die or pair of dice using the same primary colours as described for FIG. 1, while the numerals/factors “5” and 10” are presented with a different colour such as green, black or grey. A single die or set (pair) of dice according to the design shown can be used with the mat designs shown in FIGS. 17 and 18 in order for the learner to select various factors and factor operations. See also Example 3 where a pair of dice may be incorporated in a kit or be provided together with one or more sets of learning aids (also referred to herein as tools), wherein a set of learning aids is understood to comprise those aids which allow a learner to discover the solution of a selected factor operation by transforming one or more of said aids by the learner's manipulation of said one or more aids, or components thereof.

FIG. 12 (a-j): Illustration of an alternative system and method for teaching and learning the multiplication of two-factor operations (e.g. “6×7”) that can be combined with the system and method of the present disclosure as shown in FIG. 10.

FIG. 13 (a-p): Illustration of an alternative system and method for teaching and learning the multiplication of two-factor operations (e.g. “7×8”) that can be combined with the system and method of the present disclosure as shown in FIG. 10.

FIG. 14 (a-h): Illustration of an alternative system and method for teaching and learning the multiplication of two-factor operations (e.g. “4×6”) that can be combined with the system and method of the present disclosure as shown in FIG. 10.

FIG. 15 (a-n): Illustration of an alternative system and method for teaching and learning the multiplication of two-factor operations (e.g. “3×7”) that can be combined with the system and method of the present disclosure as shown in FIG. 10.

FIG. 16: Illustration of sets of learning aids that can form part of a kit arranged on a board or within an open case to provide learners with options to experience the discovery of the solutions (products) to multiplication factor operations according to embodiments. Illustrated is a pair of dice, a workspace area to record a non-numerical factor operation representation and the learner' progress (e.g. using representative learning aids), a colour mixed reference tool, a question grid, answer grid, series of foldable sheets (pocket 1), multi-piece semi-circle and track tool, series of solution representation sheets or cards (pocket 2) with image embedded numeric products (solutions) of the factor operations rolled using the dice, and a series of substantially transparent with laminates (pocket 3) for overlaying on top of the solution representation sheets or cards and printed with the numeral products which are superimposed over the image embedded numeric products of the solution representation sheets or cards.

FIG. 17: Illustration of an assembled multi-piece semi-circle and track tool according to embodiments of the present disclosure.

FIG. 18: Illustration of the pieces of the multi-piece semi-circle and track tool of FIG. 17, according to embodiments of the present disclosure.

FIG. 19: Illustration of a variation of the solution representations illustrations shown in FIGS. 6 and 7 according to embodiments of the present disclosure, including image embedded numeric solutions corresponding to the depicted solution representation.

FIG. 20: Illustration of an exemplary factor operation (6×6) selected by a learner according to embodiments of the present disclosure and a set of aids available in a kit including manipulative (grouping) aids for learners to manipulate and discover the solution of the selected (e.g. dice rolled) factor operation as further described in Example 3 of the present disclosure.

FIG. 21: Illustration of sets of learning aids available in a kit according to embodiments of the present disclosure to help learners discover the solution to the factor operation (6×6). The sets of learning aids include representative learning aids and visual reinforcement learning aids to assist learners to arrive at the solution using the combined methods of Examples 1 and 2 as adapted and further described in Example 3.

FIG. 22: Illustration of an exemplary factor operation (6×7) selected by a learner according to embodiments of the present disclosure and a set of aids available in a kit including manipulative (grouping) aids for learners to manipulate and discover the solution of the selected (e.g. dice rolled) factor operation as further described in Example 3 of the present disclosure.

FIG. 23: Illustration of sets of learning aids available in a kit according to embodiments of the present disclosure to help learners discover the solution to the factor operation (6×7) The sets of learning aids include representative learning aids and visual reinforcement learning aids to assist learners to arrive at the solution using the combined methods of Examples 1 and 2 as adapted and further described in Example 3.

FIG. 24: Illustration of an exemplary factor operation (6×8) selected by a learner according to embodiments of the present disclosure and a set of aids available in a kit including manipulative (grouping) aids for learners to manipulate and discover the solution of the selected (e.g. dice rolled) factor operation as further described in Example 3 of the present disclosure.

FIG. 25: Illustration of sets of learning aids available in a kit according to embodiments of the present disclosure to help learners discover the solution to the factor operation (6×8) The sets of learning aids include representative learning aids and visual reinforcement learning aids to assist learners to arrive at the solution using the combined methods of Examples 1 and 2 as adapted and further described in Example 3.

FIG. 26: Illustration of an exemplary factor operation (6×9) selected by a learner according to embodiments of the present disclosure and a set of aids available in a kit including manipulative (grouping) aids for learners to manipulate and discover the solution of the selected (e.g. dice rolled) factor operation as further described in Example 3 of the present disclosure.

FIG. 27: Illustration of sets of learning aids available in a kit according to embodiments of the present disclosure to help learners discover the solution to the factor operation (6×9) The sets of learning aids include representative learning aids and visual reinforcement learning aids to assist learners to arrive at the solution using the combined methods of Examples 1 and 2 as adapted and further described in Example 3.

FIG. 28: Illustration of an exemplary factor operation (7×7) selected by a learner according to embodiments of the present disclosure and a set of aids available in a kit including manipulative (grouping) aids for learners to manipulate and discover the solution of the selected (e.g. dice rolled) factor operation as further described in Example 3 of the present disclosure.

FIG. 29: Illustration of sets of learning aids available in a kit according to embodiments of the present disclosure to help learners discover the solution to the factor operation (7×7). The sets of learning aids include representative learning aids and visual reinforcement learning aids to assist learners to arrive at the solution using the combined methods of Examples 1 and 2 as adapted and further described in Example 3.

FIG. 30: Illustration of an exemplary factor operation (7×8) selected by a learner according to embodiments of the present disclosure and a set of aids available in a kit including manipulative (grouping) aids for learners to manipulate and discover the solution of the selected (e.g. dice rolled) factor operation as further described in Example 3 of the present disclosure.

FIG. 31: Illustration of sets of learning aids available in a kit according to embodiments of the present disclosure to help learners discover the solution to the factor operation (7×8). The sets of learning aids include representative learning aids and visual reinforcement learning aids to assist learners to arrive at the solution using the combined methods of Examples 1 and 2 as adapted and further described in Example 3.

FIG. 32: Illustration of an exemplary factor operation (7×9) selected by a learner according to embodiments of the present disclosure and a set of aids available in a kit including manipulative (grouping) aids for learners to manipulate and discover the solution of the selected (e.g. dice rolled) factor operation as further described in Example 3 of the present disclosure.

FIG. 33: Illustration of sets of learning aids available in a kit according to embodiments of the present disclosure to help learners discover the solution to the factor operation (7×9). The sets of learning aids include representative learning aids and visual reinforcement learning aids to assist learners to arrive at the solution using the combined methods of Examples 1 and 2 as adapted and further described in Example 3.

FIG. 34: Illustration of an exemplary factor operation (8×8) selected by a learner according to embodiments of the present disclosure and a set of aids available in a kit including manipulative (grouping) aids for learners to manipulate and discover the solution of the selected (e.g. dice rolled) factor operation as further described in Example 3 of the present disclosure.

FIG. 35: Illustration of sets of learning aids available in a kit according to embodiments of the present disclosure to help learners discover the solution to the factor operation (8×8). The sets of learning aids include representative learning aids and visual reinforcement learning aids to assist learners to arrive at the solution using the combined methods of Examples 1 and 2 as adapted and further described in Example 3.

FIG. 36: Illustration of an exemplary factor operation (8×9) selected by a learner according to embodiments of the present disclosure and a set of aids available in a kit including manipulative (grouping) aids for learners to manipulate and discover the solution of the selected (e.g. dice rolled) factor operation as further described in Example 3 of the present disclosure.

FIG. 37: Illustration of sets of learning aids available in a kit according to embodiments of the present disclosure to help learners discover the solution to the factor operation (8×9). The sets of learning aids include representative learning aids and visual reinforcement learning aids to assist learners to arrive at the solution using the combined methods of Examples 1 and 2 as adapted and further described in Example 3.

FIG. 38: Illustration of an exemplary factor operation (9×9) selected by a learner according to embodiments of the present disclosure and a set of aids available in a kit including manipulative (grouping) aids for learners to manipulate and discover the solution of the selected (e.g. dice rolled) factor operation as further described in Example 3 of the present disclosure.

FIG. 39: Illustration of sets of learning aids available in a kit according to embodiments of the present disclosure to help learners discover the solution to the factor operation (9×9). The sets of learning aids include representative learning aids and visual reinforcement learning aids to assist learners to arrive at the solution using the combined methods of Examples 1 and 2 as adapted and further described in Example 3.

### DETAILED DESCRIPTION OF THE INVENTION

The present invention relates to the field of teaching and learning systems for multiplication and division operations, for example, involving two-numeral operations with values ranging from “3” to “12” for learners who have already mastered multiplication operations using the numerals “1”, “2”, “5’ and “10”. Further mastery of multiplication and division operations according to the present disclosure also allows for the application of the system and method provided herein to numerals greater than “12” and for operations which involve more than two numerals.

As demonstrated herein, a versatile system and method is disclosed which can apply numerous kinds of devices, articles and system configurations for learners to master multiplication and division operations.

Various features of the invention will become apparent from the following detailed description taken together with the illustrations in the Figures. The design factors, construction and use of the system and method disclosed herein are described with reference to various examples representing embodiments, which are not intended to limit the scope of the invention as described and claimed herein. The skilled technician in the field to which the invention pertains will appreciate that there may be other variations, examples and embodiments of the invention not disclosed herein that may be practiced according to the teachings of the present disclosure without departing from the scope and spirit of the invention.

### Definitions

Unless defined otherwise, all technical and scientific terms used herein have the same meaning as commonly understood by one of ordinary skill in the art to which this invention pertains.

The use of the word “a” or “an” when used herein in conjunction with the term “comprising” may mean “one,” but it is also consistent with the meaning of “one or more,” “at least one” and “one or more than one.”

As used herein, the terms “comprising,” “having,” “including” and “containing,” and grammatical variations thereof, are inclusive or open-ended and do not exclude additional, unrecited elements and/or method steps. The term “consisting essentially of” when used herein in connection with a composition, device, article, system, use or method, denotes that additional elements and/or method steps may be present, but that these additions do not materially affect the manner in which the recited system and method (including any compositions, devices and articles of various embodiments, or different uses) function. The term “consisting of” when used herein in connection with a composition, device, article, system, use or method, excludes the presence of additional elements and/or method steps. A composition, device, article, system, use or method described herein as comprising certain elements and/or steps may also, in certain embodiments consist essentially of those elements and/or steps, and in other embodiments consist of those elements and/or steps, whether or not these embodiments are specifically referred to.

As used herein, the term “about” refers to an approximately +/−10% variation from a given value. It is to be understood that such a variation is always included in any given value provided herein, whether or not it is specifically referred to.

The recitation of ranges herein is intended to convey both the ranges and individual values falling within the ranges, to the same place value as the numerals used to denote the range, unless otherwise indicated herein.

The use of any examples or exemplary language, e.g. “such as”, “exemplary embodiment”, “illustrative embodiment” and “for example” is intended to illustrate or denote aspects, embodiments, variations, elements or features relating to the invention and not intended to limit the scope of the invention.

As used herein, the terms “connect”, “connection” and “connected” refer to any direct or indirect, tangible or intangible association between elements or features of the system and method of the present disclosure, as well as to processes which correlate certain information to other information. Accordingly, these terms may be understood to denote elements or features that are partly or completely contained within one another, attached, coupled, disposed on, joined together, matched, coordinated, linked, etc., even if there are other elements or features intervening between the elements or features described as being connected, or multiple steps for correlating one bit of information to another bit of information.

As used herein, the term “attribute” refers to a part, or aspect of a representation that can be identified (sensed) using one or more sensory skills (e.g. sight, hearing, touch, smell, taste), such as, but not limited to a feature, characteristic or quality of an image, physical entity, sensation(s), or sound(s). A sensible attribute may also be expressed as a combination of other attributes. Certain attributes according to the present disclosure may be used, or applied to identify or represent numerals (e.g. factors and products), to perform non-numerical operations, correlate and derive representations, or to decode or discover (numerical) information.

As used herein, the term “colour” is used to describe individually and collectively primary and complementary colours, tints, hues and shades of colours, white and black, and generally, all visual manifestations or representations of products of colour mixing, or blending.

As used herein, the terms “expression(s)”, “express” and “expressed” refer to a particular manifestation (tangible and intangible) of an idea, concept, entity, relationship, method, and process for the purposes of facilitating human communication, knowledge, comprehension, making, creation and innovation. The distinguishing function, features, aspects, or qualities of different expression(s) may give rise to distinguishable or distinct representations and attributes according to the present disclosure.

As used herein, the term “factor” refers to a numeral which forms part of a multiplication operation (expression) to be solved. Since the system and method of the present disclosure allows for the mastery of division operations based on developing a mastery of multiplication operations, a factor may also be correlated to, or used to describe a divisor or quotient of a division operation.

The term “media” is used herein in its broadest sense and is therefore to be understood according to the context in which it is used herein, and generally understood to refer to: 1) physical objects, elements or features configured to provide sensible numerical and/or non-numerical representations by way or fixation or other means of making said representations accessible to the sensing capabilities of a learner; and/or 2) physical objects, elements or features used by a learner to perform a numerical or non-numerical operation. For example, representations may be fixed onto paper, boards, fabric, blocks, chips, or magnets or accessible from computer readable media, while sound-making devices, crayons, chalk, markers, paints, coloured and/or textured cards, chips, blocks or magnets may be media used to perform a non-numerical operation, such as a colour mixing operation, or to otherwise record factor operation representations (numerical and non-numerical) and solutions (products of the factor operations that a learner will discover using the learning aids of the present disclosure.

As used herein, the term “operation” refers to carrying out one or more steps which require problem solving skill(s) to be applied to a problem to arrive at a result. An operation may be represented as the problem to be solved or as the series of steps that need to be taken to arrive at a result. Various mathematical or numerical operations may include, but are not limited to multiplication, division, addition and subtraction. Non-numerical operations may include, but are not limited to, computer or software code operations, and operations based on scientific and engineering principles (e.g. colour theory, chemistry, physics, etc.). Without limitation, an operation may comprise the application of a series of correlation and matching steps and/or the application of provided or acquired knowledge of STEM principles or concepts. An operation may also include the application of fine arts and language skills, alone, or as steps in addition to the application of STEM-based problem solving skills (STEAM) to execute an operation (e.g. using the senses, motor skills and vocalizations).

As used herein, the term “representation” refers to an alternative expression of a pre-existing expression that can be or is correlated (corresponds) to said pre-existing expression for the purposes of working the system and method according to the present disclosure.

It is contemplated that any embodiment of the compositions, devices, articles, methods and uses disclosed herein can be implemented by one skilled in the art, as is, or by making such variations or equivalents without departing from the scope and spirit of the invention.

### System of Non-Numerical Representations for Factors, Factor Operations and Solutions

The system and method of the present disclosure break down the process of discovering and learning the solution to a factor operation by creating a set of surrogate (non-numerical) expressions that account for each element of a multiplication or division equation (i.e. the factors, factor operation and solution). Non-numerical representations selected to represent numerical parts of a multiplication or division equation, are selected to be distinguishable (distinct) from one another, and able to be manipulated or applied so as support the development of multiple problem solving skills.

While the prior art has utilized non-numerical surrogate expressions for numerals and solutions previously, such expressions have tended to use such expressions for representing the factors and solutions only, and to prefer to apply the same representations for the same numerals, wherever they appear in the operation or solution.

Moreover, prior approaches have not been designed to facilitate the application of a non-numerical operation to derive a factor operation representation, as a distinct representation from each of the factor representations and solution representation. The non-numerical operation of the present system and method is executed using one or more attributes of the factor representations to derive (or create) the distinct factor operation representation. Accordingly, the non-numerical operation can be understood as a transformation or manipulation of the factor representations rather than simply working with a compilation of the factor representations.

By creating a factor operation representation that is removed from the confines of the format of the numerical operation, a demarcation, pivot or grounding point is provided for in the system and method to open up the design of the solution representations encoding the solution to a plethora of options adapted to the learning styles and strengths of learners. This system and method configuration provides another level of problem solving following the non-numerical operation and allows learners to track the decoded or discovered solution (via the factor operation representation) back to the starting subject (numerical) operation. The tracking capability is provided by means of one or more (sensible) shared attributes between a factor operation representation and a solution representation. The shared attribute(s) may or may not be one or more of the attributes of the factor operation representation that were derived by applying the non-numerical operation to the factor representations.

In one embodiment, two factor representations (of factors to be combined into a single factor operation) are used to derive a single factor operation representation (using a non-numerical operation) and the factor operation representation is applied with a solution representation (leveraging a shared attribute) to decode or discover the numerical solution.

In another embodiment, three or more factor representations are used to derive new, intermediate factor representations, factor operation representations and solution representations, as part of a more complex multiplication or division problem. In a related embodiment the complex multiplication or division problem is based on three factors combined into a single factor operation. In a further embodiment, the complex multiplication or division problem is based on four factors combined into a single factor operation. In still another embodiment, the complex multiplication or division problem is based on two pairs of factors each combined into first and second two factor operations, the numerical solutions to which are then used to form a third two factor operation.

For example, starting with three factor representations (representing three factors to be combined into a single factor operation), two of the factors representations can be used to derive a first factor operation representation using a non-numerical operation. The first factor operation representation can then function as a fourth factor representation to be applied with the third factor representation to derive a second factor operation representation. The second factor operation representation will, in turn, be applied with a first solution representation (leveraging a shared attribute) to arrive at the numerical solution for the original three factor operation.

Alternatively, working with three factor representations (representing three factors combined into a single factor operation), two of the factors representations can, again, be used to derive a first factor operation representation using a non-numerical operation. This time, however, the first factor operation representation is applied with a distinct (first) solution representation (again leveraging a shared attribute) to arrive at a numerical solution. This numerical solution can be assigned a distinct (fourth) factor representation and used with the third factor representation to derive a distinct (second) factor operation representation. The second factor operation representation in this instance would then be applied with a further (second) solution representation to decode or discover the final numerical solution to the original three factor operation.

In one embodiment of the system and method, the non-numerical representations are visual representations. In another embodiment, the non-numerical representations are auditory representations. In still another embodiment the non-numerical representations are tactile/kinesthetic representations. In related embodiments, the non-numerical representations are combinations of visual, auditory and tactile/kinesthetic representations.

To make the delivery of the system and method more engaging for learners, the level of interactivity can be supported using various technologies, environments and instruction that support and promote vocalization and physical activity. This requires the fixing of, or ability to generate the non-numerical representations using one or more of a variety of media (e.g. paints, crayons, colouring pencils, markers; alternatively, coloured stickers, cards, tokens, blocks or game playing pieces of various shapes), and/or learning aids.

In certain embodiments of the system and method, visual representations are fixed to or generated using one or more learning aids such as paper, computer memory (and generated, e.g. projected as or at a light display) and 3D articles or devices. In one embodiment of the system and method, the visual representations are fixed in a workbook or worksheets. In another embodiment, each visual representation is fixed to a device or article, such as, but not limited to, blocks, balls, flip cards, learning (spinner) wheels, discs, dice, dominos, and the like. A group of visual representations fixed to such devices or articles may or may not be configurable on boards, frames or other support structures designed to accommodate the movement, sorting, storing and/or manipulation of the fixed visual representations (e.g. an abacus-like structure).

In yet another embodiment, visual representations are generated using electronic devices, systems and methods, such as projection at or proximal to a video display. In a still another embodiment, visual representations are projected to a floor or wall, or as a hologram in a space. In a further embodiment, visual representations are presented or generated using assistive technologies for learners with disabilities (e.g. computer vocalizations of visual representations for vision impaired learners). In one embodiment, visual representations are presented within a video game. In a related embodiment, visual representations are presented within a virtual reality system.

In still another related embodiment, visual representations may be displayed on a mobile hand-held device used to generate short video, which animate the visual representations displayed in a workbook or other tangible medium for displaying static images. Such short video (e.g. in mp4 format) can be used to help highlight for the user the salient features of the representation that can be used to perform derivation steps to obtain factor operation representations and perform decoding/discovery steps to obtain numerical solutions from the solution representations.

In some embodiments of the system and method, auditory representations are generated and delivered as musical notes or sounds. In one embodiment, the auditory representations are the notes of one or more musical scales. In another embodiment, the auditory representations are selected from sounds experienced in different environments, such as natural habitats and industrial settings. In still a further embodiment, the auditory representations are generated using articles made of different materials such as metals, glass, wood, plastic and the like. In a further embodiment, the auditory representations are generated using an electronic device, computerized sound synthesizer system and the like.

In still other embodiments of the system and method, kinesthetic representations are provided as objects with touch distinguishable surfaces and features, or as objects used to perform various activities or actions. Exemplary textured surfaces include, but not are limited to, different types of fabrics, metal, glass, plastics and wood materials. Exemplary categories of touch-distinguishable objects/features include, but not are limited to, fruit and vegetables, garden specimens, differently sized blocks and balls, and discs with perforations or elevated protrusions.

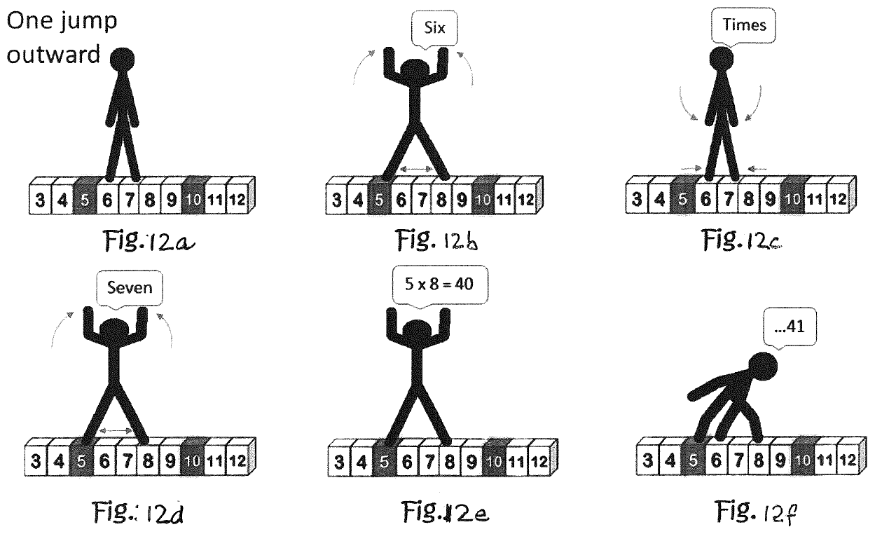

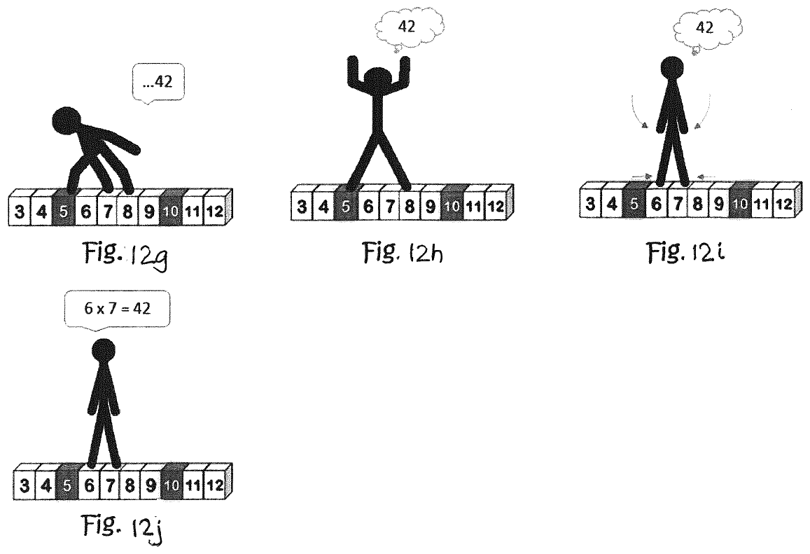

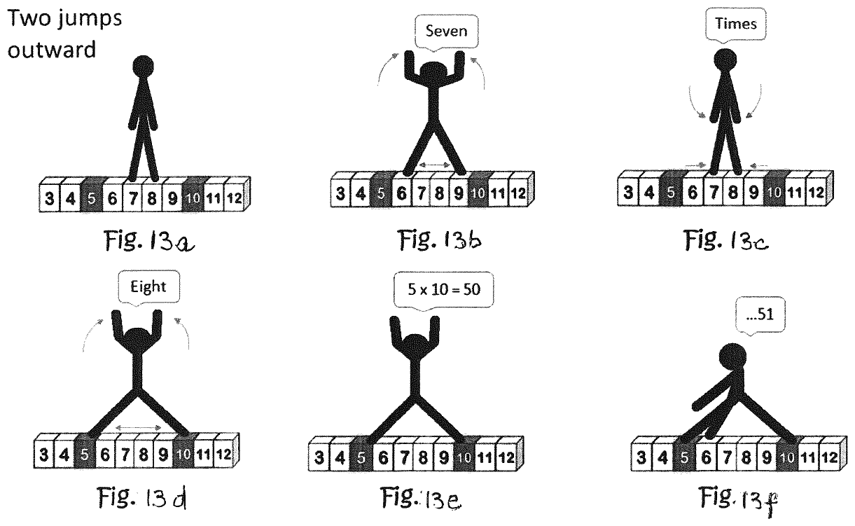

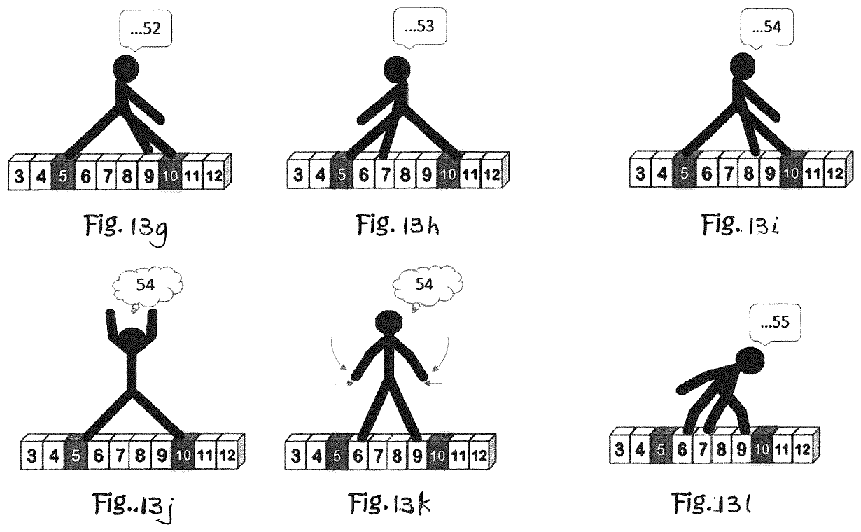

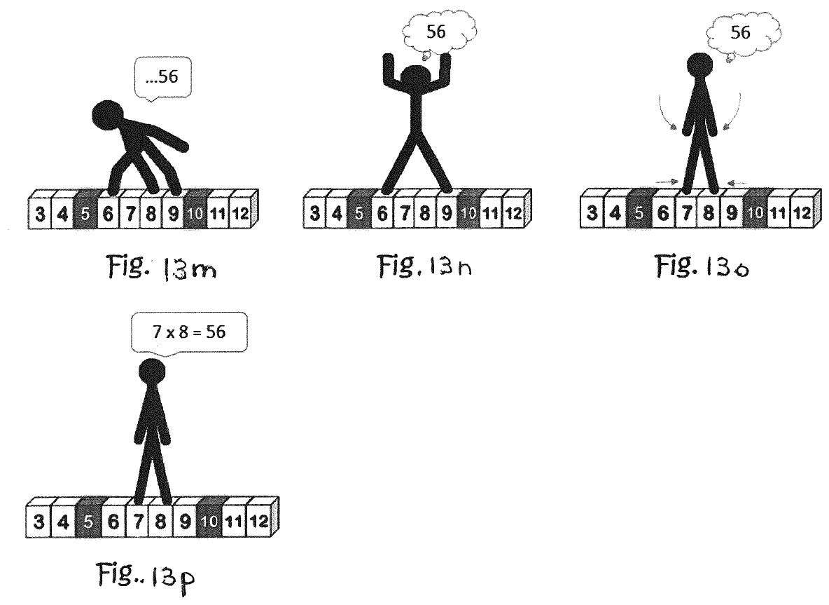

In another embodiment, textual aids can be provided to enhance engagement and provide clues or instructions for using system and performing the method of the present disclosure. For example, with reference to FIGS. 12 and 13, the solution representations can be decoded or discovered with the aid of story-telling techniques, written or told, as exemplified in Example 2.

Categories or groupings of factor representations (based on one or more distinguishable attributes) are selected so as to provide a basis and scheme for performing the non-numerical operation to derive the factor operation representations. In one embodiment, colour can be applied as the distinguishing attribute of factor representations and manipulated using colour theory to derive factor operation representations. In another embodiment, foods or food ingredients (factor representations) selected from various food groups can be applied to derive balanced meals (factor operation representations) according to nutritional science. In still another embodiment, seeds and the elements needed for germination (factor representations) can be used to derive different plants (factor operation representations) according to plant science. In a further embodiment, two musical notes from a chord (factor representations), visually or audibly conveyed, can be used (as the attributes used to derive the third note that completes the chord (factor operation representations).

The solution representations need not fit into or form part of the scheme of factor representations so long as one or more attributes of the derived factor operation representations is/are shared with the corresponding solution representations. The function of the solution representation is to be a self-contained encoding of the product (solution) of the subject numerical operation. The versatility of the solution representations that can be designed arises by not requiring the factor representations to represent the same numerals in the solution representation. Nor does the shared attribute between the solution representation and corresponding factor operation representation have to be part of the “coding” for the numerical solution. The primary shared attribute(s) function is as a tracking mechanism for the learner to match the solution decoded or discovered from the solution representation back to the starting (subject) numerical operation.

In one embodiment, different attributes of the solution representation encode different numerals in the solution to a (numerical) factor operation. In another embodiment, different attributes of the solution representation encode two or more surrogate numerical expressions of the solution to a factor operation and cues to add and/or subtract the expressions to/from one another to obtain the solution to the factor operation.

### Methods for Using System of Non-Numerical Representations for Factors, Factor Operations and Solutions

The application of the system of the present disclosure comprising non-numerical factor representations, factor operation representations and solution representations is as a teaching and learning method for multiplication and division operations. Learners are able to self-teach using the system according to the present disclosure to the extent and degree they choose. Embodiments of the system may be provided as kits (see Examples 1 and 3) providing the non-numerical representations for the factors, factor operations and solutions in the form of various learning aid components, such as, but not limited to workbooks, mats, blocks, electronic hand-held devices, and instructional components for working with the learning aid components (i.e. non-numerical representations).

The versatility of the system and method according to the present disclosure is its modular design and staged process to work through a given multiplication or division problem, as well as the cross-curricular opportunities it offers for integrating STEM, social studies, and fine arts/language strands from school curriculums. This supports the development of knowledge and problem solving skills reflecting the application of concepts and ideas covered in curriculums. The system and method of the present disclosure also support the needs of learners with varying aptitudes, and provide options for learning multiplication and division operations in a fun and engaging manner. The opportunities for cross-curricular integration in the deployment of the system and method in schools allow for its application in classroom and gymnasium settings, and for group instruction, peer learning and self-instruction formats.

In one embodiment, the method according to the present disclosure comprises the step of identifying or correlating a set of distinct factor representations to a set of numerical factors (which form part of possible subject factor operations), deriving the factor operation representation by performing a non-numerical operation using the applicable factor representations, correlating the factor operation representation to a solution representation on the basis of one or more shared attributes and decoding or discovering the solution representation to discover and obtain the solution to a given subject factor operation.

Additional steps can be included in the method to pre-test a learner's knowledge, ability to solve various factor operations and/or validate the solution obtained using the method according to the disclosure. This allows the learner to determine which factor operations to solve using the system and method of the present disclosure. Other steps can be incorporated to reinforce the learners ability to perform any one or more of the steps for solving the factor operation, such as exercises to more readily identify the factor representations for the factors, exercises to practice the application of the non-numerical operation to derive the factor operation representations and using alternative systems and methods for double checking the solution decoded or discovered from the solution representations.

To gain a better understanding of the invention described herein, the following examples are set forth. It will be understood that these examples are intended to describe illustrative embodiments of the invention and are not intended to limit the scope of the invention in any way.

### EXAMPLES

The following examples are illustrative of the system and method according to the present disclosure and described with reference to the figures/drawings indicated. Each implementation of the system and method described below relates to providing learners with a means to: (1) solve two-numeral multiplication and division, with numerals in the range of “3” to “12”; (2) develop logic and math based skills in a way which can be experienced or leveraged using cross-curricular subject matter, multiple sensory and cognitive pathways, and skills; and (3) obtain the support needed to learn subject (numerical) operations to a degree and extent that the learner controls (which has a positive impact on learner self-esteem).

### Example 1: Exemplary System and Method for Multiplication of Numerals 6, 7, 8, and 9 (Colour Mix Approach)

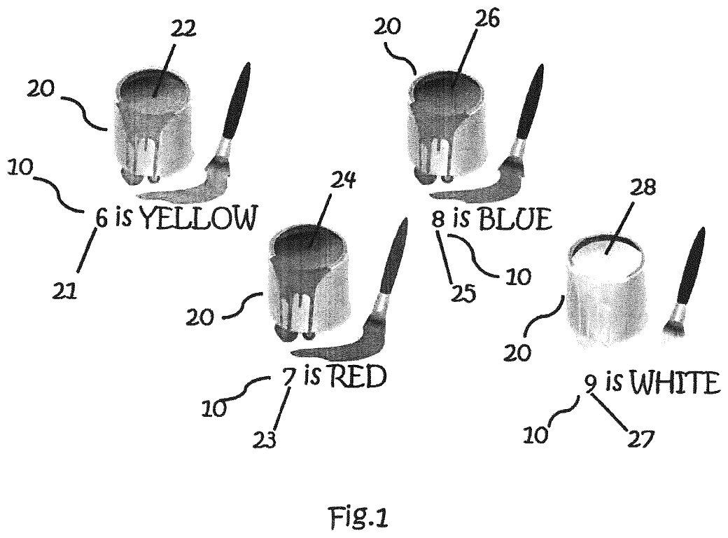

In one embodiment of the system and method according to the present disclosure, FIG. 1 provides the factor representations 20 for the factors 10 that will be applied by the learner to learn how to multiply the numerals six to nine in simple two factor operations. The factors 10 for the numerals six 21, seven 23, eight 25 and nine 27 are assigned a primary colour or white as an attribute of their respective factor representations 20 where: the colour yellow 22 is an attribute of the factor representation 20 for the numeral/factor 10, six 21; the colour red 24 is an attribute of the factor representation 20 for the factor 10, seven 23; the colour blue 26 is an attribute of the factor representation 20 for the factor 10, eight 25; and the colour white 28 is an attribute of the factor 10, nine 27.

The factor representations 20 may have additional attributes such as the form of paint cans and their respective brushes to make the imagery more memorable as well as to give an indicator of the type of non-numerical factor operation that will be applied when using the factor representations 20 to derive the factor operation representation.

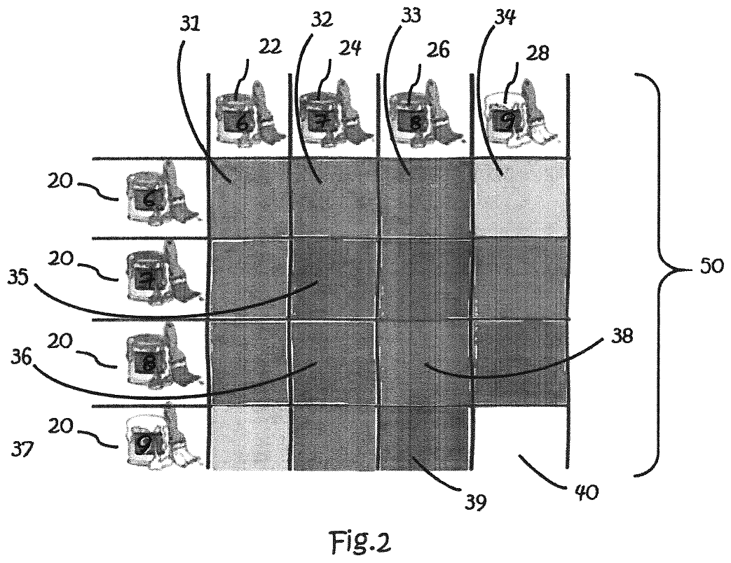

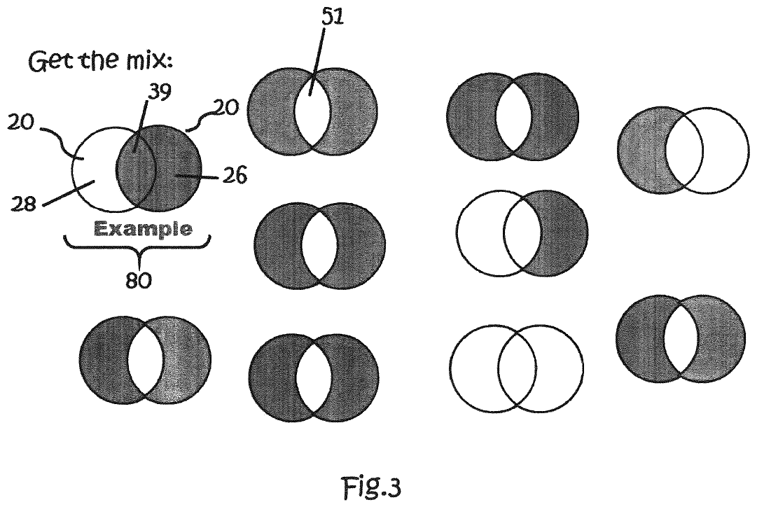

FIG. 2 illustrates the non-numerical operation (and instructions in a tabular format) performed by the learner with the factor representations 20. The non-numerical operation entails mixing or blending two of the primary colour or white attributes 22, 24, 26 and 28, respectively, to derive the factor operation representations 50. By performing the colour mixing operation using one or more of a variety of media, distinguishing colour attributes 31-40 of the factor operation representations 50 are produced (derived).

More specifically, each numerical factor operation (and its product) aligns with a derived factor operation representation attribute (FORA) based on mixing two-factor representation attributes (FRAs) indicated along each axis of the grid/table in FIG. 2 as follows:
1. 6×6 is represented by mixing the FRAs, yellow 22 with yellow 22 to derive the FORA, yellow 31;
2. 6×7 is represented by mixing the FRAs, yellow 22 with red 24 to derive the FORA, orange 32;
3. 6×8 is represented by mixing the FRAs, yellow 22 with blue 26 to derive the FORA, green 33;
4. 6×9 is represented by mixing the FRAs, yellow 22 with white 28 to derive the FORA, light yellow 34;
5. 7×7 is represented by mixing the FRAs red 24 and red 24 to derive the FORA, red 35;
6. 7×8 is represented by mixing the FRAs, red 24 and blue 26 to derive the FORA, purple 36;
7. 7×9 is represented by mixing the FRAs, red 24 and white 28 to derive the FORA, pink (light red) 37;
8. 8×8 is represented by mixing the FRAs, blue 26 and blue 26 to derive the FORA, blue 38; and
9. 8×9 is represented by mixing the FRAs, blue 26 and white 28 to derive the FORA, light blue 39; and
10. 9×9 is represented by mixing the FRAs, white 28 and white 28 to derive the FORA, white 40.

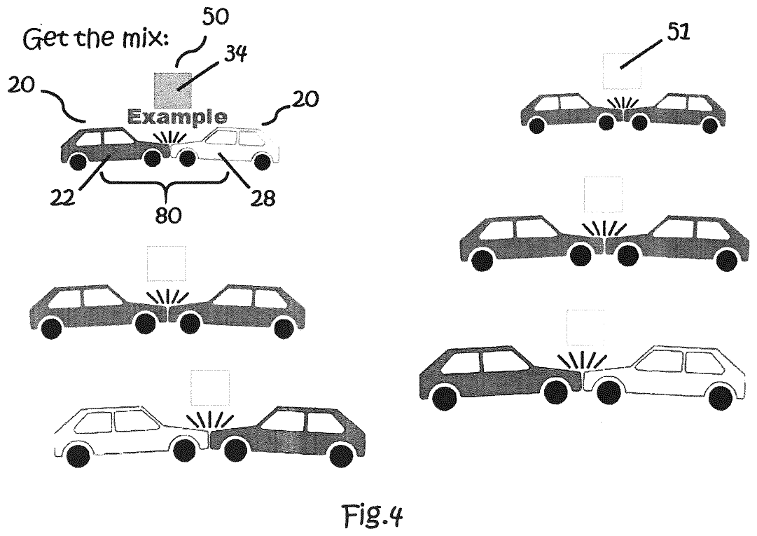

As further illustrated in FIGS. 3 and 4, the learner can practice the colour mixing (non-numerical) operation 80 in various ways to derive a factor operation representation 50 by colouring in the space 51 provided where the factor representations 20 overlap (circles in FIG. 3), or else proximal to where the factor representations meet (cars colliding in FIG. 4).

While certain attributes of the factor representations 20 can change as shown in FIGS. 3 and 4 (i.e. circle shapes in FIG. 3 and car images in FIG. 4) and even be shared between factor representations (e.g. all of the factor representations are car images in FIG. 4), there is at least one attribute which distinguishes each factor representation from other factor representations (such as different colours) and which is used to perform the non-numerical operation (colour mixing using one or more of a variety of media) to derive a corresponding factor operation representation 50.

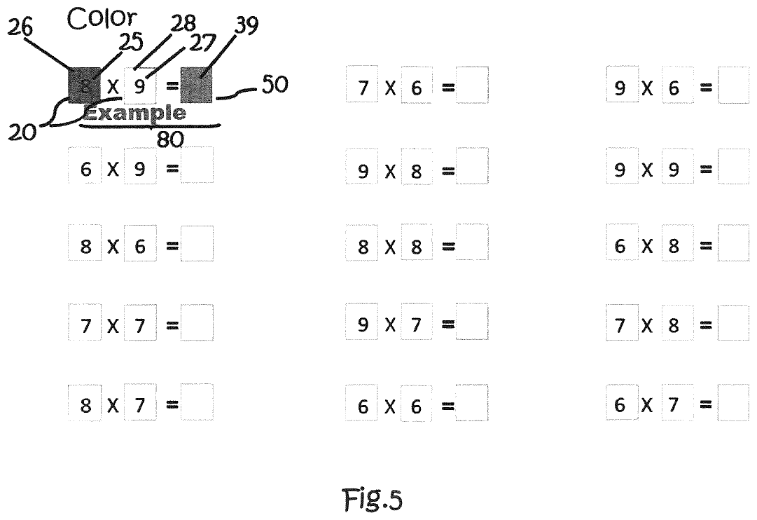

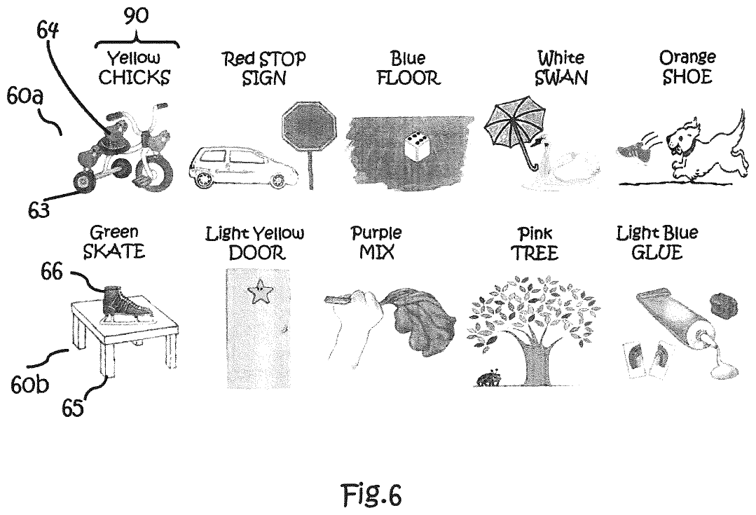

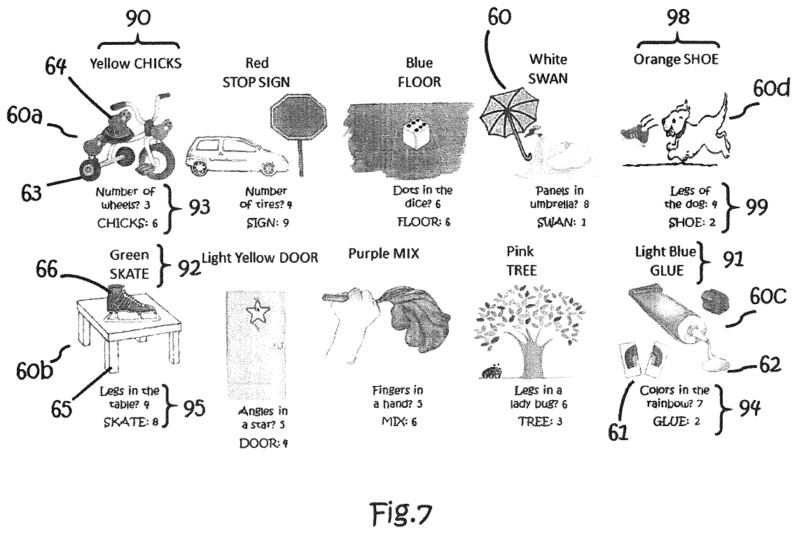

This is demonstrated further in FIG. 5, where the factor representations 20 are coloured squares overlaid over their corresponding numerical factors, eight 25 and nine 27, and their respective colour attributes 26 and 28 are mixed by the learner to derive the factor operation representation 50 comprising the colour attribute 39. Set out in a familiar factor operation format, a factor operation representation 80 can also be readily correlated with the product of the factor operation and accordingly with a solution representation (shown generally as 60 and exemplified particularly as 60a, 60b, 60c and 60d) in FIGS. 6 and 7. In these figures, the particular factor operation representation 50, with colour attribute 39 (light blue), from FIG. 5, correlates with the solution representation 60c comprising the image attribute 62 shown as (light blue) glue. A word title 91 is also provided to help the learner focus on the attribute 62 of the solution representation. This title 91 can be understood as another attribute of the solution representation, which functions as an aspect of the instructions for decoding or discovering the solution representation in the form of a clue.

The use of multiple attributes in non-numerical representations, as demonstrated in this instance, allows for the application of the system and method according to the present disclosure when not all of the attributes can be sensed or processed with the same degree of ease. In the case of the “Light Blue GLUE” title/attribute 91 the learner is provided a means for decoding or discovering that particular solution representation 60c, even if the colour of the glue image is not apparent, e.g. because the learner has a vision disability (colour blindness), or because of the image being reproduced in black and white. Similarly, the system and method can be configured so that the title/attribute 91 is provided as an auditory cue attribute, or in brail (textured attribute) for learners who are blind or visually impaired.

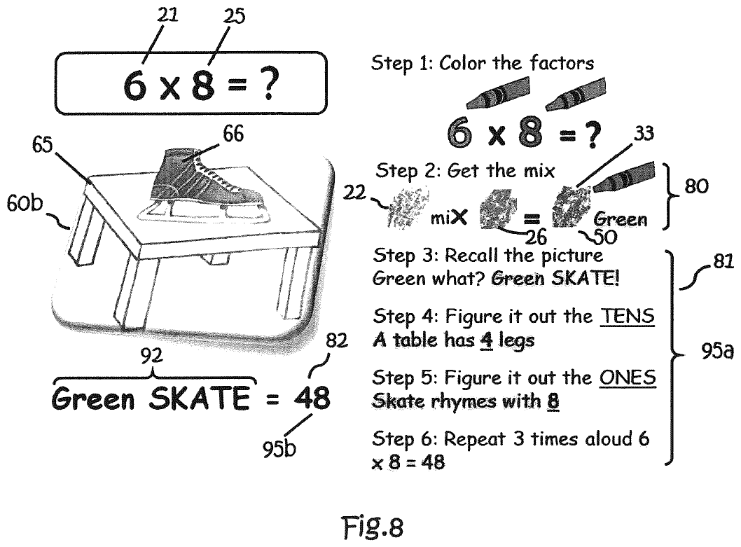

To decode a solution representation 60 and obtain the product (numerical solution 81) of a factor operation, the learner is provided with guidelines or instructions (a logic operation) with reference to various attributes, as shown in FIG. 7 for a given solution representation. The combined logic and product solution feature of the system and method is labelled in a generalized sense as feature 81 of FIG. 8 with reference to the solution representation 60b from FIG. 7, where the specific decoding logic and numerical solution (product) for this solution representation is labelled as feature 95 in FIG. 7 and still more particularly as features 95a and 95b, respectively, in FIG. 8.

Applying the generalized logic to the solution representation entitled “Light Blue GLUE”, two or more of the attributes of the solution representation are used to decode the product/solution “72” of the factor operation “8×9”. Coupled with the light blue glue 62 and title 91 is an image of a rainbow 61. With reference to feature 94 of FIG. 7, the rainbow attribute 61 with its seven colours provides the numeral “7”. To obtain the numeral “2” a rhyme association is made by sounding out the terms “GLUE” and “two” having regard to the image attribute(s) light blue glue 62 and/or the title 91 “Light Blue GLUE”.

The capitalization of all of the letters of the term “GLUE” to be sounded out, in contrast to the descriptor “Light Blue” provides a visual cue regarding the instructions and also exemplifies how the colour attribute used to correlate the factor operation representation to the solution representation (to the product of the factor operation), need not necessarily be used to decode the solution/product itself.

The method described above for discovering and learning the solution of a given factor operation is consistently applied to decode the ‘tens’ and ‘ones’ place value numerals of the solutions (products) of the subject factor operations the learner is presented with (having regard to the respective factor operation representation and solution representation pairings). As shown in FIGS. 6 and 7, the solution “36” and logic for discovering the solution (labelled as feature 93 in FIG. 7) to the factor operation “6×6” is discovered by correlating the factor operation representation colour attribute, yellow 31 (from FIG. 2) to the same colour attribute appearing in the solution representation 60a with the title attribute “Yellow CHICKS” 90. The image of the tricycle has three wheels from which to decode the numeral “3” (‘tens’ place value) and the numeral “6” (‘ones’ place value) is decoded based on sounding out and hearing the rhyme between the terms “CHICKS” and “six” (again with reference to the title 90 and/or chick image 64).

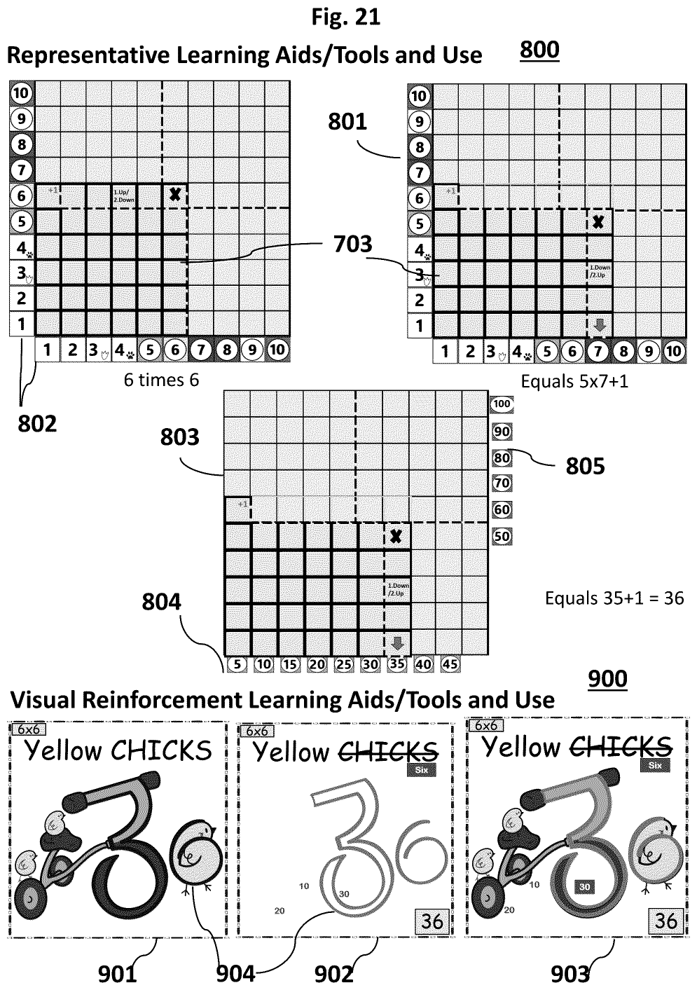

With reference to FIG. 8, the exemplary system and method for a colour mixing approach to discovering and learning the product 95 for the factor operation “6×8” (i.e. “48”) is set out. On a general level, the process steps of decoding a solution representation is indicated by the feature label 81 and the resulting numerical product by the feature 82. With reference to the specific example shown, the learner is first guided to correlate the factors 21 (numeral “6”) and 25 (numeral “8”) to distinct non-numerical, factor representations, with colour attributes, yellow 22 and blue 26, respectively (Step 1). The colour attributes of the (non-numerical) factor representations are mixed according to a non-numerical operation 80 (i.e. using colour science) to derive a factor operation representation 50 with the colour attribute, green 33 (Step 2). Using the logic operation 95a for the solution representation 60b the learner is guided to discover the numerical solution 95b. The green attribute 33 of the factor operation representation is a shared attribute with the solution representation 60b comprising several distinguishing attributes, including but not necessarily limited to, a title (“Green SKATE”) 92, image of a green skate 66 and a table 65. The shared green attribute 33 facilitates the correlation of the factor operation representation 50 to the solution representation 60b (Step 3). The four legs of the table image 65 provide the numeral “4” of the solution (Step 4) and sounding out the rhyme association between the terms “SKATE” and “eight” provide the numeral “8” of the solution (Step 5). The final association/connection between the original factor operation “6×8” is then made with the discovered solution/product “48” (Step 6). In other embodiments the discovery of the solution need not require the learner to decode the ‘tens’ and ‘ones’ place value numerals of the solutions (products) of the subject factor operations the learner is presented with. By way of example and with reference to FIG. 21, the actual numeric solution may be visually embedded in imagery (solution representations). The numeric solution is visible in both solution representation imagery provided and in partially, or completely stripped back or deconstructed images provided as laminates (transparencies) printed with the numeric solutions. Each laminate with a printed numeric solution thereon can be overlaid on top of the corresponding printed solution representation images (e.g. printed on sheets, cards, plates, boards, blocks and the like) to reveal where the numeric solution is embedded in the imagery of the solution representation. See Example 3 where a combination of printed solution representations with embedded numeric solutions are coupled with laminates as described herein as a visual reinforcement of the solution (product) discovery process the learner has engaged and experienced using other learning aids.

In one embodiment, a method of teaching or learning multiplication comprises the steps of: a) providing a learner with a set of learning aids that can be physically engaged by the learner to provide and reveal to the learner a sixteen square grid, with a first set of numeral and colour pairings arranged along a horizontal axis of the grid, and a second set of numeral and colour pairings arranged along a vertical axis of the grid, each set of pairings consisting of a numeral 6 and yellow colour pairing, a numeral 7 and red colour pairing, a numeral 8 and blue colour pairing, and a numeral 9 and white colour pairing, wherein the learner performs a colour mixing operation using media to: (i) mix a colour in a pairing along the horizontal axis with a colour in a pairing along the vertical axis to obtain a mixed colour, and ii) colour a square of the grid located at an intersection of a column of the grid aligned with the pairing along the horizontal axis and a row of the grid aligned with the pairing along the vertical axis using the mixed colour; and b) providing the learner with another learning aid, such as the mat with the semi-circle and track features described in Example 2 that include the solution representations 60 shown in FIGS. 6 and 7.

### Example 2: Exemplary Combination System and Method for Multiplication and Division of Numerals 6, 7, 8, and 9

The system and method according to the present disclosure may be combined with other approaches for teaching and learning multiplication and division. The objective for doing so is to provide learners with additional options for using different cognitive pathways for teaching and learning multiplication using sensory (e.g. visual, auditory, and/or kinesthetic) reinforcement means.

A design consideration for combining systems and methods of teaching and learning multiplication and division is to identify whether an alternative system and method engages compatible cognitive processing pathways as a particular embodiment of the presently disclosed system and method. In the following exemplary embodiment, the system and method of the present disclosure is combined with an alternative system and method that also applies surrogate expression means for problem solving a factor operation.

### Alternative System and Method for Multiplication and Division of Numerals 6, 7, 8, and 9

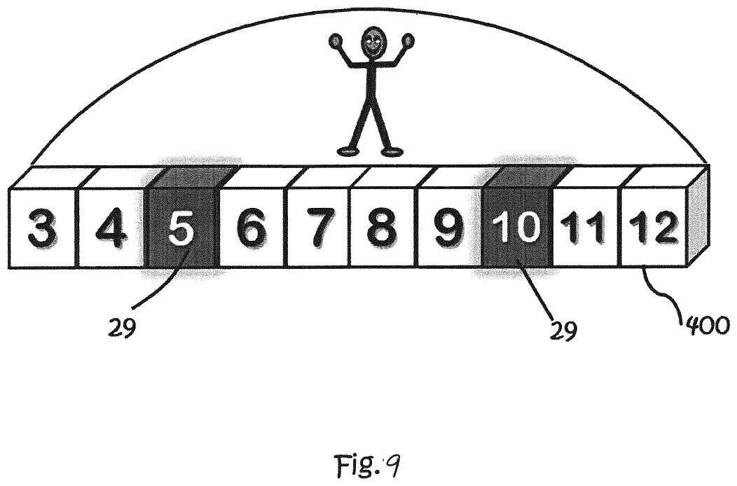

An alternative approach to learning the multiplication and division of two factor operations for numerals ranging between “3” and “12” is the system and method depicted in FIG. 9, and FIGS. 12-15. With reference to FIG. 9, the system and method are designed so that learners derive the product of a selected two-factor multiplication operation (that does not include the numerals “5” and/or “10” by working from another multiplication operation that does include the number values “5” and/or “10”, and then performing an addition or subtraction adjustment to get at the answer (product) to the selected multiplication operation. The application of a two-factor multiplication operation (new operation) with the numeral(s) “5” and/or “10” with the addition or subtraction of an adjustment create a numerical surrogate expression (operation) for the subject operation.

More particularly, learners use an educational device (displaying a numbered track 400) and apply a series of operations using their mastery of multiplication operations involving the numbers “5” and “10” to solve multiplication and division operations when the multipliers and products, and divisors and quotients are in the range of numbers from “3” to “12”, but other than “5” and/or “10”. The educational device displaying the numbered track 400 distinguishes the numerals “5” and “10” by giving the expression of each of these numerals in their boxes a colour attribute 29 (e.g. black or grey) different from the colour attributes of the other factors along the track.

This system and method shown in more detail in FIGS. 12-15 is represented as a series of steps that can be carried out using visual, auditory and kinesthetic cues to help learners solve two factor multiplication operations for factors from “3” to “12”. The steps involve the use of a teaching aid device(s), such as a track on a mat, and proceed in sequence by selecting a two factor operation that does not include the factor(s) “5” and/or “10”, discovering the answer (product/solution) beginning with a factor operation that includes the factor(s) “5” and/or “10”, followed by applying a set of rules to make an adjustment using addition and subtraction operations.

FIGS. 12-15 present the four general possible set of movements and visual processing steps to represent and solve multiplication and division operations using the alternative system and method for multipliers (factors) and products, divisors and quotients in the range of numbers from “3” to “12”.

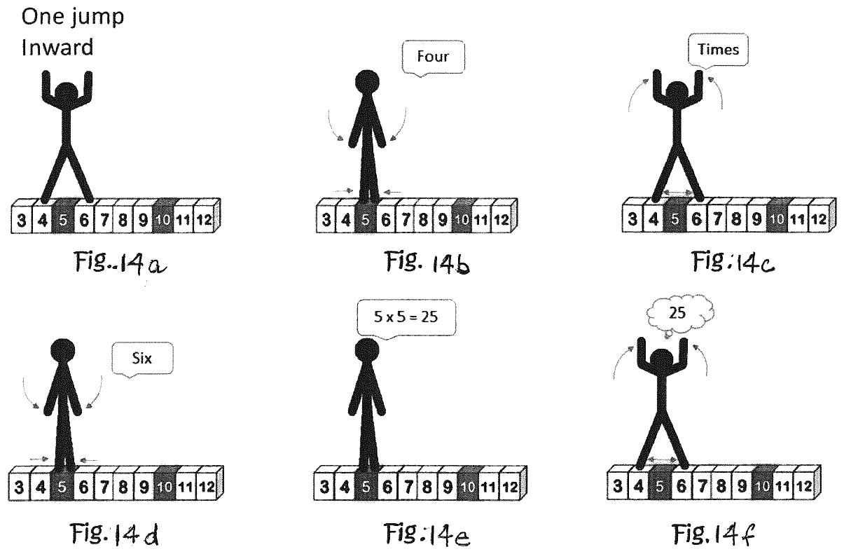

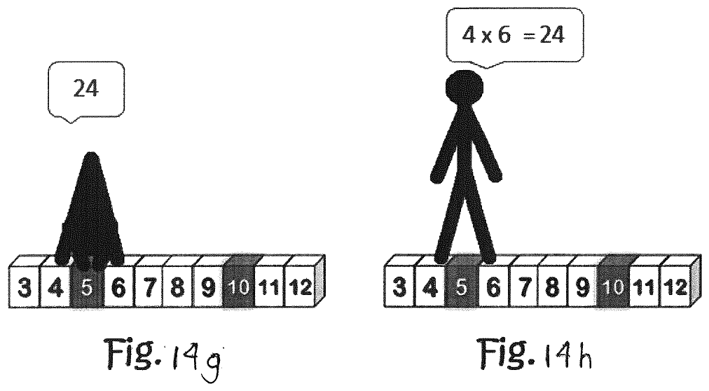

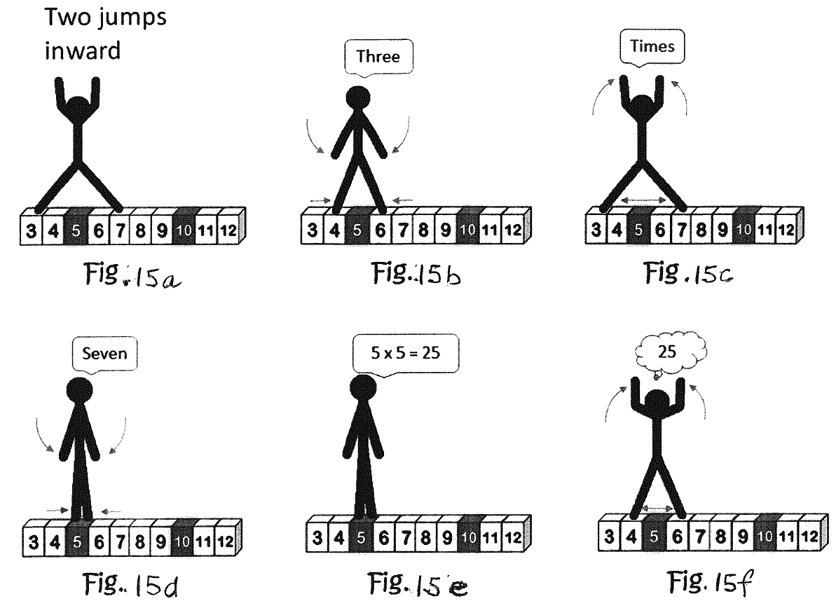

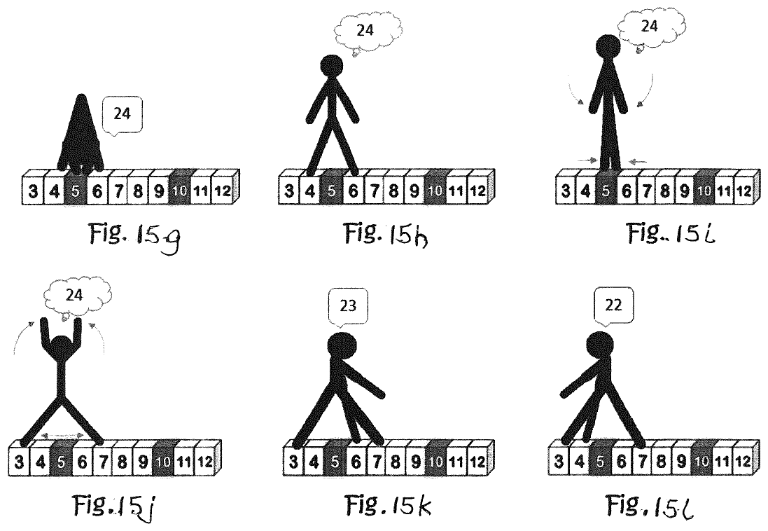

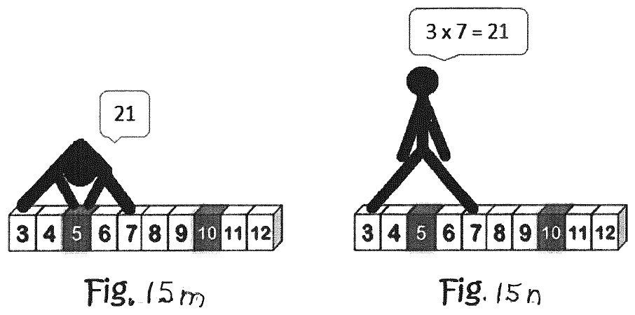

With regard to solving two factor multiplication operations, the methods shown involve a learner: (i) moving one step outward in both directions on the track from the subject operation to get the new multiplication operation that includes the factors “5” and/or “10” (FIGS. 12a to 12b, or 12c to 12d); (ii) moving two steps outward in both directions on the track from the subject operation to get the new multiplication operation that includes the factors “5” and/or “10” (FIGS. 13a to 13b, or 13c to 13d); (iii) moving one spot inward in both directions on the track from the subject operation to get the new multiplication operation that includes the factors “5” and/or “10” (FIGS. 14a to 14b, or 14c to 14d); (iv) moving two spots inward in both directions on the track from the subject operation to get the new multiplication operation that includes the factors “5” and/or “10” (FIGS. 15c to 15d).

In the examples shown in FIGS. 12-15 for various two-factor operations, learners stand on a numbered track on the floor (e.g. using a mat or projected light image) and place each foot/digit on the number values corresponding to each of the factors of the multiplication operation that does not include the factor(s) “5” and/or “10”. By default, the left foot/digit will be placed on the lower number value and the right foot/digit on the greater number value, or both feet on the same number value (with the number values in the track facing toward the learner). This way the system itself takes care of the duplications. Learners are taught to read the math fact (multiplication operation) beginning with the lowest number.

To get the answer for a given multiplication operation, the learner will physically move one or two spots outward or inward with both feet until at least one foot/digit lands on a spot with the numerical value of “5” and/or “10” of the numbered track. For engagement purposes, the learner may perform ‘jumping-jack’-like movements saying out loud the factor operation that is the subject of the exercise, e.g. “6×7” as shown in FIGS. 12a-12d. This results in the left foot/digit being placed on the value corresponding to one unit less and the right foot/digit on one unit more on the numbered track than the starting (original) positions for each foot/digit (FIGS. 12a to 12b and FIGS. 12c to 12d). When a learner jumps inward, the movements are reversed for each foot/digit (FIGS. 12b to 12c).

Once a jump moving outward or inward ends up landing on a numerical value of “5” and/or “10” with at least one foot/digit, the numerical values under each foot/digit represent each of the factors of the new multiplication operation (surrogate expression/representation) to be used to solve the subject (starting) factor operation. Using the example shown in FIG. 12 (a-j), this becomes the operation “5×8” (FIG. 12d) for the subject operation “6×7” (FIG. 12a).

When jumping outward one or two times to end up landing over the numerical values “5” and/or “10”, the adjustment will be adding to the product of the new multiplication operation, the number of values between the feet on the numbered track, after the jump to the numerical values “5” and/or “10”, to get the product of the given subject (multiplication) operation.

When jumping inward one or two times to end up landing over the numerical values “5” and/or “10”, the adjustment will be subtracting from the product of the new multiplication operation, the number of values between the feet on the numbered track before the jump to the numerical values “5” and/or “10”, to get the product of the given subject (multiplication) operation.

Division operations to obtain quotients are taught and learned as a consequence of mastering multiplication.

In one variation, the system comprises a numbered track with numerals “3” to “12” and additional components selected from flip or flashcards, spinners/wheels and dice to randomly select the multiplication facts (operations).

The numbered track can be made to be displayed in the form of a physical object, such as a mat, tiles, blocks and ruler made from any suitable material, such as vinyl, plastic, foam, cardboard, wood, and paper.

In general, when a physical numbered track on the floor is used to engage a learner to use his/her feet and/or hands is displayed on the floor, the dimensions can be adapted for learners of different sizes, such as children (e.g. grade two to four level) to be able to place their feet on it and perform the outward or inward movements according to the method. Alternatively, the system's numbered track can be displayed using light projection on a video (interactive) display/screen, on a wall or on a floor. In the case of a ruler, the learner will use finer motor skills with his/her fingers instead of the legs and/or hands to place them on the ruler's numbers (as factors) to perform the operations of the method.

To reinforce the learning process, the visual and kinesthetic steps taken along the track can also be performed audibly to help a learner calculate and remember the adjustment to be made between the product of the new operation and the product of the related subject operation by way of moving outward or inward along the track.

The most complete form of performing the method associated with the disclosed device consists of the following steps, which can be helpful to do using one's fingers or feet on the track depending on the size of the track.

To more specifically illustrate the approach of the alternative approach described above, methods for solving multiplication operations according to the present disclosure are further exemplified with reference to the figures.

FIG. 12 (12a-12j) exemplifies the steps of a method to solve the subject operation “6×7” using movement and/or vocalizations along with the visual cues provided by the numbered track. A learner places each foot/digit (or their index and middle finger/digit from one hand) on the factors on the numbered track (FIG. 12a) and then moves each foot/digit/digit outward (e.g. by doing a ‘jumping-jack’-like movement), while saying or not saying out loud “six times seven” according to a rhythm that may result in doing the movement once or twice, as shown in FIGS. 12b-12d. The movement outward results in the placement of a foot/digit on the numerals “5” and “8” (in this case by one step in both directions along the numbered track), for the learner to identify the new multiplication operation “5×8”, and then apply his/her knowledge of multiplication operations using the factor “5” to solve the new operation (FIG. 12e). The learner has the option to verbalize out loud “five times eight equals forty” (“5×8=40”).

The learner will then add an adjustment to the solution “40” equivalent to the number of spaces or numerals between his/her feet, having the option to bend down and touch the numerical values between his/her feet (i.e. the numbers “6” and “7” in this case) one at a time counting up. In doing so, the learner counts (optionally saying out loud) “forty-one” (“41”) while touching number “6” with the right hand (FIG. 12f), and then “forty-two” (“42”) while touching the number “7” with the left hand (FIG. 12g), for a total adjustment of two (“40+2=42”). The learner can either vocalize “forty-two” (“42”) as the solution to the subject operation (FIG. 12h) and/or exercise the option to move (e.g. jump) inward one step with each foot/digit to return to the original starting position and repeat “six times seven equals forty-two” (“6×7=42”) (FIGS. 12i and 12j).

FIG. 13 (13a-13p) exemplifies the steps to solve the operation “7×8” using movement and/or vocalizations along with the visual cues provided by the numbered track. A learner places each foot/digit on the factors on the numbered track (FIG. 13a) and then moves each foot/digit outward (e.g. by doing a ‘jumping-jack’-like movement), while saying or not saying out loud “seven times eight” according to a rhythm that results in doing the movement twice in a step-wise manner, as shown in FIGS. 13b-13d. Once the movement outward results in the placement of a foot/digit on the numerals “5” and “10” (in this case by a total of two steps in both directions along the numbered track) to identify the new multiplication operation “5×10”, the learner can apply his/her knowledge of multiplication operations using the factor(s) “5” and/or “10” to solve the new operation (FIG. 13e). The learner has the option to verbalize out loud “five times ten equals fifty” (“5×10=50”).

The learner will then add an adjustment to the solution “fifty” (“50”) of the new operation, having the option to bend down and touch the numerical values between his/her feet (i.e. the numbers “6, “7”, “8” and “9” in this case) and option to vocalize each step to arrive at an initial adjustment. That is, the learner counts up, one at a time, to “fifty-one” (“51”), while touching number “6” with the right hand (FIG. 13f), to “fifty-two” (“52”), while touching the number “9” with the left hand (FIG. 13g), to “fifty-three” (“53”), while touching the number “7” with the right hand (FIG. 13h) and to “fifty-four” (“54”), while touching the number “8” (FIG. 13i), for a total initial adjustment of “four” (“50+4”) to arrive at “54” (FIG. 13j). Moving another step inward in both directions to place the feet on numerals “6” and “9” (FIG. 13k), the learner continues the adjustment determination using the right and left hands to touch the numerals “7” and “8”, for an additional adjustment of “two”, and a total adjustment of “six” (“50+4+2=56”) as shown FIGS. 13l and 13m. The learner can either vocalize “fifty-six” (“56”) as the solution to the subject operation (FIG. 13n), or exercise the option to move (e.g. jump) inward one step with each foot/digit to return to the original starting position and repeat “seven times eight equals fifty-six” (“7×8=56”) (FIGS. 130 and 13p).

FIG. 14 (14a-14h) exemplifies the steps to solve the operation “4×6” using movement and/or vocalizations along with the visual cues provided by the numbered track. A learner places each foot/digit on the factors on the numbered track (FIG. 14a) and then moves each foot/digit inward (e.g. by doing a ‘jumping-jack’-like movement), while saying or not saying out loud “four times six” according to a rhythm that may result in doing the movement once or twice, as shown in FIGS. 14b-14d. Once the movement inward results in the placement of both feet on the numeral “5” to identify the new multiplication operation “5×5” (in this case by one step in both directions along the numbered track), the learner can apply his/her knowledge of multiplication operations using the factor “5” to solve the new operation (FIG. 14e). The learner has the option to verbalize out loud “five times five equals twenty-five” (“5×5=25”).

The learner will then add an adjustment to the solution “25” equivalent to the number of spaces or numerals between his/her feet, before moving them inward. This can be recalled by moving the feet outward again by a step in each direction (FIG. 14f), and then having the option to bend down and touch the numeral “5” with both hands, subtracting “one” from “twenty-five” (“25−1=24”) to obtain the solution “24” to the subject operation (FIG. 14g). The learner can then optionally vocalize the subject operation and its solution “4×6=24” as shown in FIG. 14h.

FIG. 15 (15a-15n) exemplifies the steps of a method to solve the operation “3×7” using movement and/or vocalizations along with the visual cues provided by the numbered track. A learner places each foot/digit on the factors on the numbered track (FIG. 15a) and then moves each foot/digit inward (e.g. by doing a ‘jumping-jack’-like movement), while saying or not saying out loud “three times seven” according to a rhythm that results in doing the movement twice in a step-wise manner, as shown in FIGS. 15b-15d. Once the movement outward results in the placement of both feet on the numeral “5” to identify the new multiplication operation “5×5” (in this case by a total of two steps in both directions along the numbered track), the learner can apply his/her knowledge of multiplication operations using the factor “5” to solve the new operation (FIG. 15e). The learner has the option to verbalize out loud ‘five times five equals twenty-five” (“5×5=25”).

The learner will then subtract an initial adjustment from the solution “25” equivalent to the number of spaces or numerals between his/her feet, before moving them inward. This can be recalled by moving the feet outward again by a step in each direction (FIG. 15f) to rest on the numerals “4” and “6”, and then having the option to bend down and touch the numeral “5” with both hands, subtract “one” from “twenty-five”(“25-1”) to arrive at “24” (FIG. 15h). This initial adjustment is followed by the determination of a further adjustment made by again moving each foot/digit outward (with or without an intervening ‘jumping jack’-like movement) from numeral “5”, as shown at FIG. 15i, to rest on the numerals “3” and “7”, the original starting position for the subject operation (FIG. 15j). The learner will then countdown (subtract) the additional adjustment, having the option to bend down and touch the numerical values between his/her feet (i.e. the numbers “4, “5”, and “6” in this case) and option to vocalize each step. That is, the learner counts down, one at a time to “twenty-three” (“23”), while touching number “6” with the right hand (FIG. 15k), to “twenty-two” (“22”), while touching the number “4” with the left hand (FIG. 15l), and to “twenty-one” (“21”), while touching the number “5” with both hands (FIG. 15m), for an additional adjustment of “three” (“3”) and total adjustment of “four” (“25−1−3=21”) (FIG. 15n).

It will be evident to one skilled in the art that the movement choreography described above for the numbered track system and method can be accomplished in different sequences or variations so long as the basic movement sequences outward and inward from the new operation numerals back to the subject operation are performed in the correct direction and in a step wise manner to make incremental and total adjustment determinations. For example, the counting up or counting down with a two-step adjustment the learner can use the same arm to touch each of the numerals between the feet, use both arms in a different sequence, or otherwise touch the numerals in between the feet in a different sequence or order.

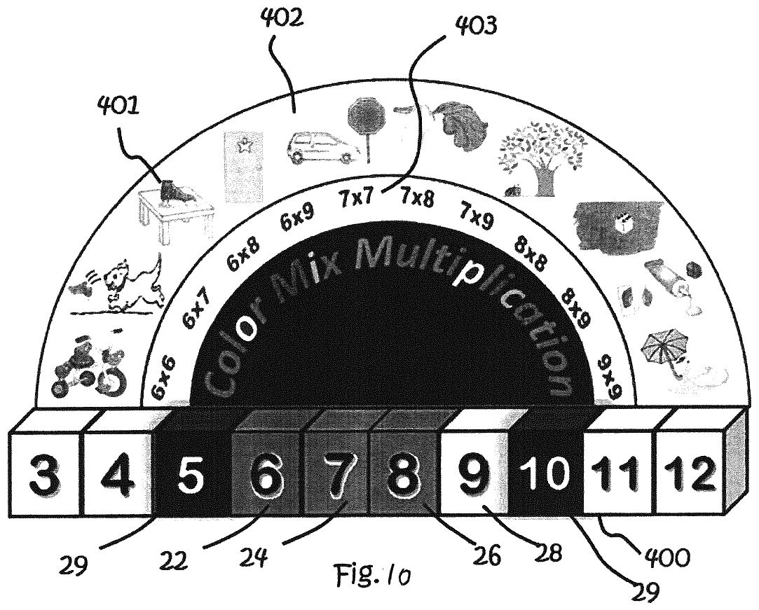

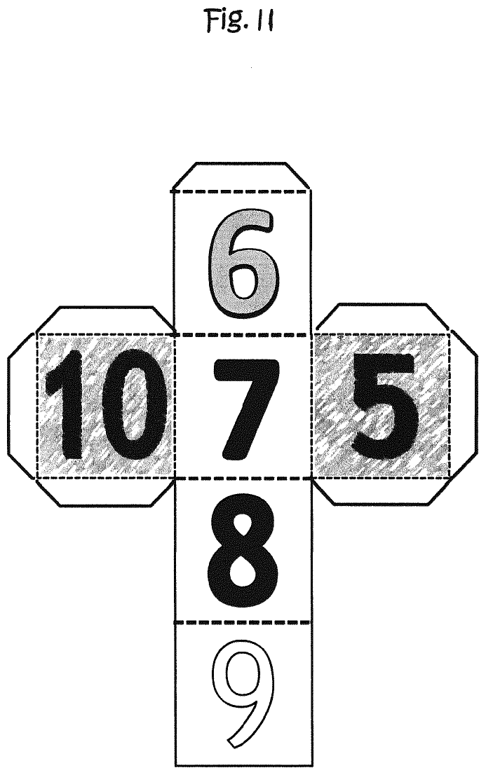

To combine the numbered track system and method of FIG. 9 with the system and method of the present disclosure, a visual integration of the features of the two systems and methods is provided in FIG. 10 where the numbered track 400 has been provided with a revised colour scheme to reflect the colour attributes of the factor representations for the numerals “6” (yellow), “7” (red), “8” (blue) and “9” (white) described in Example 1. The corresponding solution representations for the indicated factor operations are presented in a two-layer semi-circle 401 arrangement spanning the numbered track 400 where the factor operations are shown in layer 403 and the solution representations are shown in layer 402.

To use the combination system, a mat device or computer driven display of FIG. 10 is provided to the learner who can then apply either or both systems and methods for learning multiplication and division for factors ranging between “3” and “12”. Working with the specific combination configuration of FIG. 10 the learner is provided with reinforced learning opportunities for factor operations using the numerals “6”, “7”, “8′ and “9”. The learner works with the factor representations along the numbered track 400 for the indicated factor operations in layer 403 to derive the colour attribute of the corresponding factor operation representations and thereby identify and decode the corresponding solution representation in layer 402. The learner then has the opportunity to check the answer obtained using the system and method of the present disclosure using the alternative system and method according to, or analogous to FIGS. 12 and 13. The order of using one system and method are also interchangeable according to the learner's preferences.

For example, if the learning aid is a mat that can be physically engaged by a learner, the mat will have fixed and displayed thereon: a) an image of a numbered track with numerals three, four, five, six, seven, eight, nine, ten, eleven, and twelve in sequence from a left end to a right end of the numbered track, wherein the numeral six is coloured yellow, the numeral 7 is coloured red, the numeral eight is coloured blue and the numeral nine is coloured white; and b) an outline of a semi-circle running from a top left corner of the numbered track to a top right corner of the numbered track and ten paired sets of images fixed and displayed below and along the outline of the semi-circle, from the left end of the numbered track to the right end of the numbered track, a first paired set consisting of an image of an unsolved factor operation 6×6 paired with an image of three yellow chicks and a tricycle, a second paired set consisting of an image of an unsolved factor operation 6×7 paired with an image of an orange shoe and a dog, a third paired set consisting of an image of an unsolved factor operation 6×8 paired with an image of a green skate and a table, a fourth paired set consisting of an image of an unsolved factor operation 6×9 paired with an image of a light yellow door and a star, a fifth paired set consisting of an image of an unsolved factor operation 7×7 paired with an image of a red stop sign and a car, a sixth paired set consisting of an image of an unsolved factor operation 7×8 paired with an image of a purple mix and a hand, a seventh paired set consisting of an image of an unsolved factor operation 7×9 paired with an image of a pink tree and a lady bug, an eighth paired set consisting of an image of an unsolved factor operation 8×8 paired with an image of a blue floor and dice, a ninth paired set consisting of an image of an unsolved factor operation 8×9 paired with an image of light blue glue and a rainbow, and a tenth paired set consisting of an image of an unsolved factor operation 9×9 paired with an image of a white swan and an umbrella, wherein the learner: i) selects an unsolved factor operation displayed on the mat from one of the ten paired sets of images, ii) steps onto the numbered track placing their left foot/digit on the numeral matching the first factor of the selected unsolved factor operation and their right foot/digit on the numeral matching the second factor of the selected unsolved factor operation, iii) performs a colour mixing operation to obtain a colour mix product, using the colours of the numerals on the numbered track that the learner is standing on and that match the first and second factors of the selected unsolved factor operation, and iv) vocalizes a counting action and a rhyming action with reference to the image paired with the selected unsolved factor operation and presenting the same colour as the colour mix product, to sound out and hear a “tens” value and a “ones” value and thereby sound out and hear a two digit product for the selected unsolved factor operation displayed on the mat.

If the selected unsolved factor operation is 6×6, the learner may vocalize counting three wheels of the tricycle and vocalize the number six that rhymes with “chicks” to sound out and hear the product 36. If the selected unsolved factor operation is 6×7, the learner may vocalize counting four legs of the dog and vocalize the number two_that rhymes with the “shoe” to sound out and hear the product 42. If the selected unsolved factor operation is 6×8, the learner may vocalize counting four legs of the table and vocalize the number eight_that rhymes with “skate” to sound out and hear the product 48. If the selected unsolved factor operation is 6×9, the learner may vocalize counting five points of the star and vocalize the number 4 that rhymes with “door” to sound out and hear the product 54. If the selected unsolved factor operation is 7×7, the learner may vocalize counting four wheels of the car and vocalize the number nine that rhymes with “sign” to sound out and hear the product 49. If the selected unsolved factor operation is 7×8, the learner may vocalize counting five fingers of the hand and vocalize the number six that rhymes with “mix” to sound out and hear the product 56. If the selected unsolved factor operation is 7×9, the learner may vocalize counting six legs of the lady bug and vocalize the number three that rhymes with “tree” to sound out and hear the product 63. If the selected unsolved factor operation is 8×8, the learner may vocalize counting six dots of the dice and vocalize the number four that rhymes with “floor” to sound out and hear the product 64. If the selected unsolved factor operation is 8×9, the learner may vocalize counting seven colours of the rainbow and vocalize the number two_that rhymes with “glue” to sound out and hear the product 72. If the selected unsolved factor operation is 9×9, the learner may vocalize counting eight sections of the umbrella and vocalize the number one that rhymes with “swan” to sound out and hear the product 81.

### Example 3

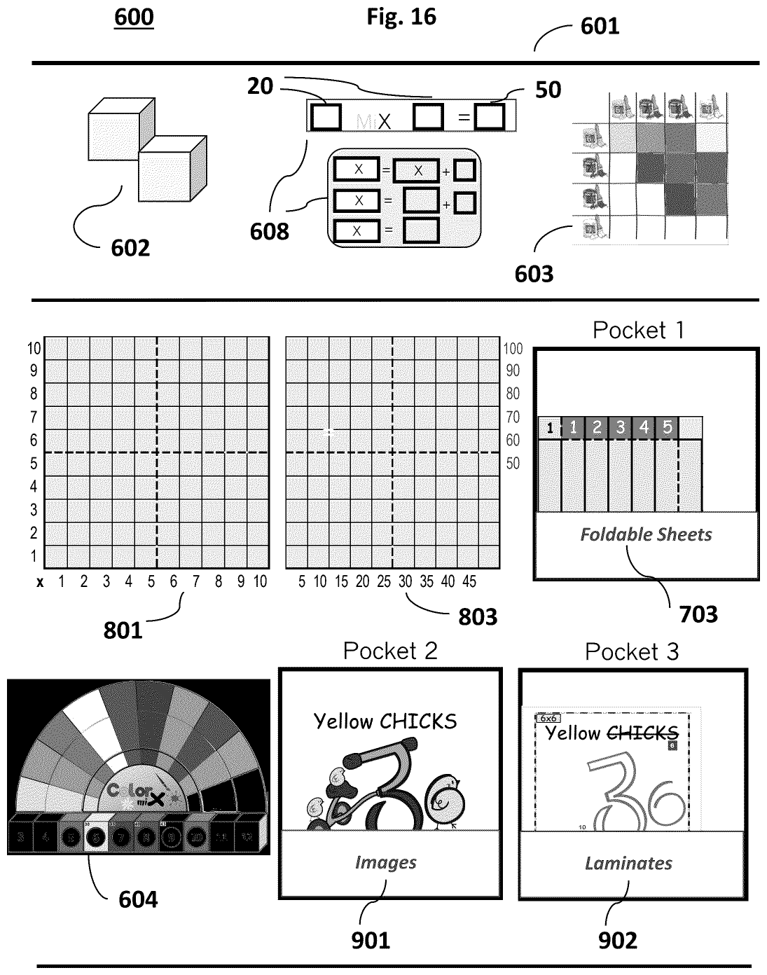

An exemplary (colour mix) kit 600 with sets of learning aids is provided with reference to FIGS. 16 to 39. The kit 600 may be provided as a package of learning aids with or without a board or casing 601 for assembling and laying out the learning aids to facilitate the organization and use of the kit's learning aids. If providing a board or casing 601, it may be made of cardboard, plastic, wood or metal, or any combination of said materials. The board/casing 601 may also be configured for the use of different learning aids in different areas that are delineated from one another and may include storage compartments, such as pockets for storing sheets, chips, cards, or laminates; and/or separate containers that can be removed and stowed in the board/casing 601 for such aids (i.e. articles), e.g. dice, chips and magnets.

FIG. 16 illustrates sets of learning aids and, optionally, a set of dice 602 with the design shown in FIG. 11. The dice 602 optionally included in the kit 600, or with a given set of learning aids as described in this Example 3 allows the learner to select the particular numerical factor operation they wish to discover the solution for.

As shown in FIG. 16, there can be provided an optional factor operation workspace surface or area 608 that may be in the form of a worksheet, or reusable board region configured as a white board, chalkboard, magnetic board, or cork board area to which can be applied colouring, writing, card, chip or magnet media to fill in the colour representations 20 of the numerical factors 10 as shown in FIG. 1 and as also shown on the dice 602 when rolled by a learner (see FIG. 11). Also recorded in the optional workspace 608 is the colour of the factor operation representation 50 obtained with reference to the colour mixed grid (reference tool) 603 providing a mixed colour corresponding to the result of mixing the factor colour representations as described in Example 1. For example, in the top row of the workspace area 608 a learner may record the colours for each factor to then seek the colour of factor operation representation 50 in the colour mixed reference tool 603. In the second row of the workspace 608, the learner may record the numerical transformation of the selected factor operation, e.g. 6×6 to 5×7+1, as revealed by manipulating the yellow foldable sheet 703 on the question grid 801, as described in this Example 3. Then by upon transposing the manipulated foldable sheet 703 to the answer grid 803, the learner can write in the third row of the workspace 608 the solution of the 5×operation (5×7 in this case), with the addition of the ‘y’ value (in this case the ‘1’) and then write in the solution on the fourth line to discover that the solution to the 5×7+1 equation tracked on the right side of the 2^{nd} to 4^{th} rows of the workspace 608 is the solution of the originally selected numerical factor operation.

The kit may comprise one or more sets of learning aids to give a learner choice about how they wish to experience discovering the solution (product) of multiplication (numerical) factor operations, using the system and methods of the present disclosure. Described in this Example 3 are two such sets of learning aids. Each set of learning aids is based on a set of colours, each associated with the product of a given factor operation using two factors selected from the numerals 6 to 9 and using said colours to provide pathways for learners to discover the solutions (products) of a selected factor operation. The methods of using said sets of learning aids may comprise applying or performing one or more colour mixing operations to obtain the colour associated with the product of the selected factor operation before using one or more of the sets of learning aids which can provided as physical learning aids or digital learning aids using a computerized system.

### Colour Mix Kit Components

In one embodiment, a set of learning aids comprising various pieces for the assembly and disassembly of a semi-circle and track tool used to provide a pathway for the learner to discover the solution (product) of one or more multiplication (numerical) factor operations. The use of this tool can be combined with a colour mixed reference tool.

In another embodiment, a set of learning aids comprising grids for placing and manipulating foldable sheets provides a pathway for the learner to discover the solution (product) of one or more multiplication (numerical) factor operations. The use of these learning aids can be combined with a colour mixed reference tool.

As will be readily appreciated, any of the sets of learning aids described in this Example 3, can be used apart from and independently from other sets of learning aids in the exemplified kit 600, to provide the learner with an experience of discovering the numerical solution to a numerical factor operation according to the present disclosure

### Colour Mixed Reference Tool

Illustrated in FIG. 16 is a colour mixed reference tool 603 for use in conjunction with various sets of learning aids and itself being a learning aid that can form part of other sets of learning aids described herein. The tool 603 can be displayed in the form of the colour mixed grid as illustrated in FIG. 2, and may be constructed using and fixed on various media, such as paper/cardboard or otherwise printed on, moulded, engraved, or carved into a kit board/casing 601. The completed colour mixed grid (reference tool) 603 is created by applying the colours associated with the numerals 6 to 9 as illustrated in FIG. 1. This colour mixed reference tool 603 may be provided to the learner with all of the mixed colours filled into the grid's boxes or the learner can make the colour mixed reference tool 603 by colouring the grid boxes using colouring media, or placing coloured pieces (cards, chips, magnets) into each grid box thereby participating in the transformation of this learning aid as part of their experience.

### Multi-Piece Semi-Circle and Track Tool

In the bottom left corner of FIG. 16 there is illustrated as part of the kit 600 a multi-piece semi-circle and track learning tool 604 similar to the tool shown in FIG. 10, but made of various pieces (learning aids) for learners to construct and deconstruct the semi-circle and track learning tool in order to discover the multiplication factor operations and numerical solutions to those factor operations, working with the numerals (factors) 6 to 9, their respective colour representations and the mixed colours represented in the colour mixed reference tool 603, corresponding to factor operation representations 50.

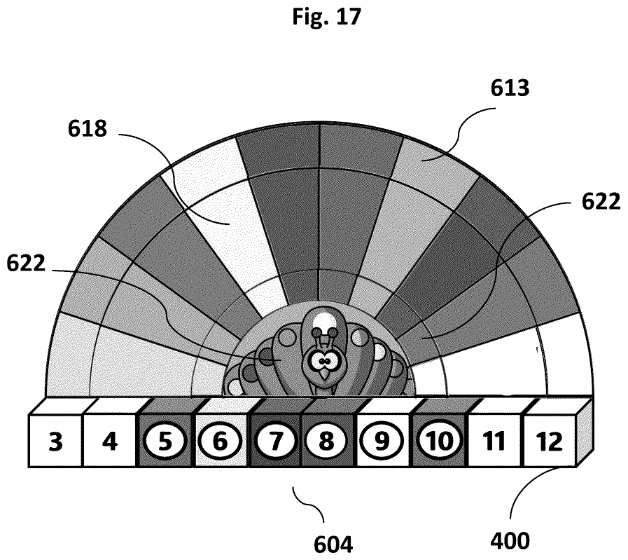

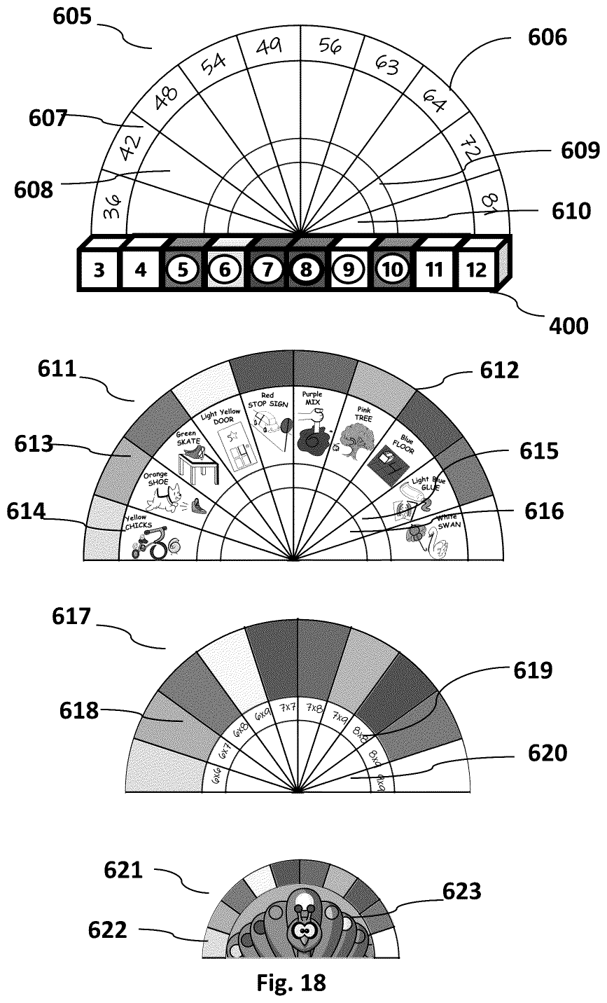

The multi-piece semi-circle and track learning tool 604 is shown in more detail in FIGS. 17 and 18 to illustrate the various pieces that can be combined to construct the assembled format of the tool 604 (see FIG. 17) and how the pieces can be disassembled to deconstruct the tool 604 (see FIG. 18). The various pieces can be made of card-stock, plastic, wood, chipboard, metal or like materials that allow for easy overlay of one piece over another.

With reference to FIG. 18, the first (base) piece 605 of the semi-circle and track learning tool 604 includes the track 400 and a first semi-circle 606 spanning the numbered track 400. The numbered track 400 is the same track shown in FIG. 10 and can be used as conceptually described in Example 2 with regard to mat and computer system embodiments. The numerical solutions to the numerical factor operations using the factors 6 to 9 are displayed (e.g. printed) in the outermost layer 607 of said first semi-circle 606. The second 608, third 609 and fourth 610 inner layers of the first semi-circle are left blank.

The second (semi-circle) piece 611 of the multi-piece semi-circle and track learning tool 604 is a second semi-circle 612 which also spans the length of the track 400. The outermost layer 613 has the colours of the factor operation representations 50 in the same spots which correspond to the numerical solutions of the numerical factor operations shown in the outermost layer 607 of the first semi-circle 606. When the second piece 611 is placed over the first piece 605 the mixed colours of the corresponding factor operation representations 50 in the outermost layer 613 cover the numerical solution of the numerical factor operations corresponding to the factor operation representations 50. The inner second layer 614 of the second piece 611 is below the outermost layer 613 and displays the solution representations 60 corresponding to the numeric solution of the numerical factor operation and corresponding to the respective mixed colours of the corresponding factor operation representations 50. The third 615 and fourth 616 inner layers of the second (semi-circle) piece 611 are left blank.

The third (semi-circle) piece 617 has three layers. When placed over the second piece 611 its outermost layer 618 overlays the second (inner) layer 614 of the second piece 611. Displayed in the outermost layer 618 of the third piece 617 is the same arrangement of the colours of the factor operation representations 50 displayed in the outermost layer 613 of the second piece 611. When the third piece 617 is placed over the second piece 611, the outermost layer 618 covers the solution representation layer 614 of the second piece 611 with same colours of the outermost layer 613, lining up with the colours of the outermost layer 618. The second (inner) layer 619 of the third piece 617 presents the numerical factor operations placed under the mixed colours of the corresponding factor operation representations 50. The third inner layer 620 of the third piece 617 is left blank.

The fourth (semi-circle) piece 621 has two layers. The outmost layer 622 has same arrangement of the mixed colours of the factor operation representations 50 displayed in the outermost layer 613 of the second piece 611 and outermost layer 618 of the third piece 617. When the fourth piece 621 is placed over the third piece 617, the outermost layer 622 covers the second layer 619 (displaying the numerical factor operations). The inner layer 623 of the fourth piece 621 may be left blank or display imagery of choice, such as a branding element, story element, symbol, or character presented as part of the kit or set of learning aids, to add visual interest, illustrative appeal, or otherwise help to engage the learner using the kit, or set of learning aids.

When the multi-piece semi-circle and track 604 is fully assembled with all four pieces, an arrangement of mixed colour segments is created around the semi-circular aspect of the learning tool 604 such that the series of mixed colour segments reinforce the association of certain colours with factor operations and their solutions. In other words, a learner is able to follow the path of discovery from a numerical factor operation to a numerical solution (product) by following the path of the displayed mixed colours provided on each piece of the learning tool 600.

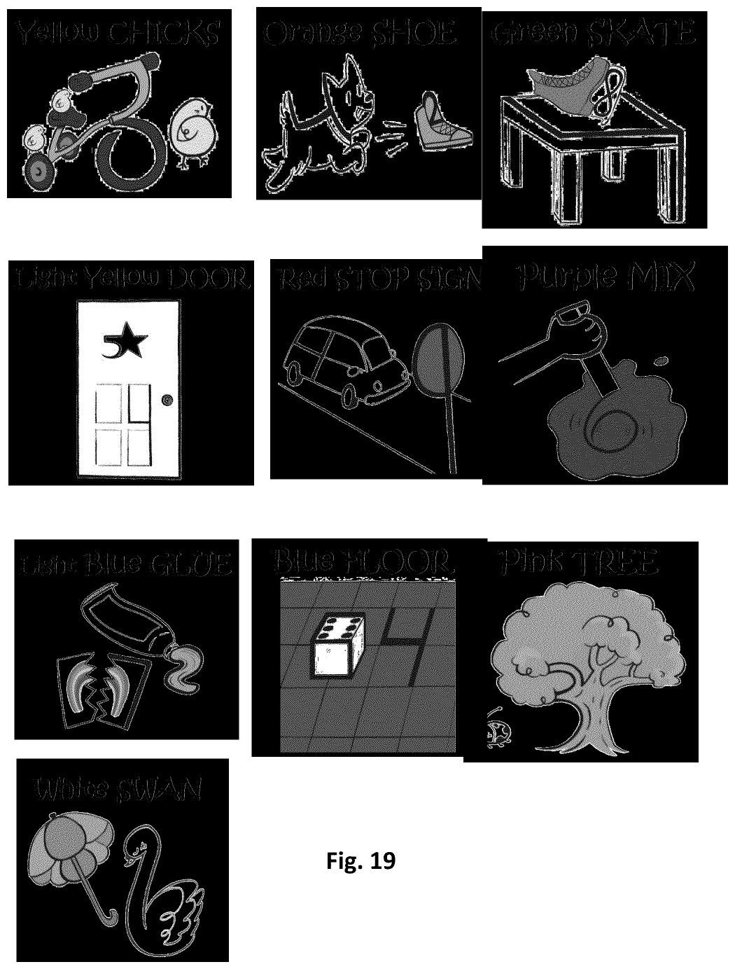

More particularly, the learner assembles, or is presented with an assembled, multi-piece semi-circle and track 604. The learner removes in sequence the fourth 621, third 617 and second 611 pieces from on top of the piece below it, respectively. Starting by removing the fourth piece 621 from on top of the third piece 617, the series of numerical factor operations (using various combinations of factors 6 to 9) displayed in the second (inner) layer 619 of the third piece 617 and the corresponding factor operation representations 50 in the form of a mixed colour are revealed to the learner. The learner can then remove the third piece 617 from on top of the second piece 611 to reveal the solution representations 60 (e.g. as shown in FIG. 6 and FIG. 19) that correspond to the numerical factor operations using various combinations of factors 6 to 9 and their corresponding factor operation representations 50 in the form of a mixed colour. The learner can then remove the second piece 611 from on top of the first piece 605 to reveal the numerical solution corresponding to each solution representations 60 in the second layer 614 of the second piece 611 and the numerical factor operation displayed in the second layer 619 of the third piece 617, all of which are presented in a given pie-shaped segment around the semi-circle framework of the learning tool 604, and associated in said segment with the same mixed colour attribute.

### Foldable Sheet (Representative) Learning Aids

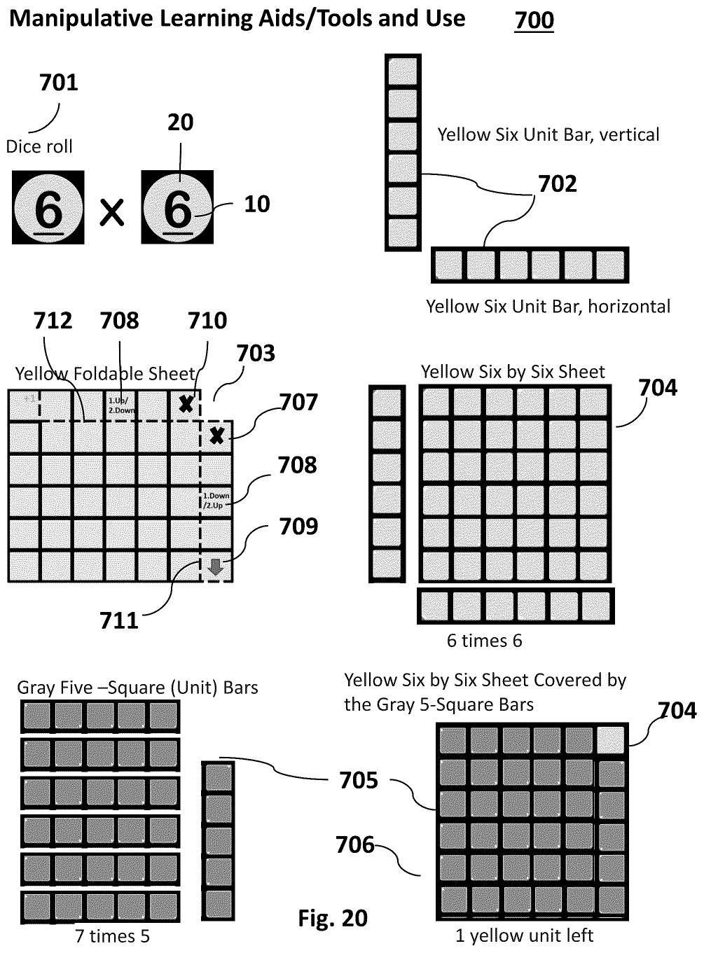

FIGS. 20-39 together illustrate three types of learning aid sets 700, 800 and 900 that can be used by a learner to discover the solution to a factor operation selected by the learner (e.g. as revealed by a dice roll 701). Since each die has each of the factors 10 (e.g. as labelled in FIG. 21; namely, factors 6 to 9) associated with a primary colour representation 20 as illustrated in FIGS. 1 and 2, the learner can use the colour mixed reference tool 603 (see FIG. 16) to obtain the factor operation representation 50, which is the mixed colour from the grid box of the reference tool 603 as described herein with reference to FIG. 2.

With reference to FIGS. 21, 23, 25, 27, 29, 31, 33, 35, 37 and 39, sets of learning aids 800 is illustrated, one set for solving each factor operation using the numeric factors 6 to 9 . . . . The learner uses the colour of the factor operation representation 50 obtained from the colour mixed reference tool 603 to select the foldable grid sheet 703 that corresponds to said colour of the factor operation representation 50. The learner manipulates the sheet 703 in order to place it on a question grid (also referred to as a mat herein) 801 and then on the solution (answer) grid (also referred to as a mat herein) 803 to discover the numeric solution (product) of the selected numerical factor operation. To assist the learner to discover the numeric solution through the various steps of manipulating the foldable sheets 703 on the question grid 801 and answer grid 803, the foldable sheets 703 may be labelled with further indicators and symbols, such as the multiplication symbol “X” at the right end of the foldable top row 710, and at the top end of the foldable right column 707 of the sheet 703 (see FIG. 20). Indicators 708 provide the order of manipulating foldable row 710 and foldable column 707. A firstly folded sheet 703 is the result of folding down column 707 (under the sheet 703) while leaving foldable row 710 up (unfolded). A secondly folded sheet 703 is the result of folding up (unfolding) column 707 and then folding down the foldable portion of row 710 (under the sheet 703). Arrow 709 is used to reveal the solution of the secondly folded sheet 703 when placed on the answer grid 803 as further described in this Example 3.

Notable features of the question grid 801 include numbered tracks 802 with numerals 1 to 10 along the ‘x’ and ‘y’ axes of the question grid 801. The factors 3 to 10 of said tracks 802 are associated with the same colours as the factors on numbered track 400 as shown in FIGS. 6 and 19. The numbered tracks 802 allow the learner to place the foldable sheet 703 with the selected colour corresponding to the factor operation representation 50, onto the question grid 801 aligned with the numerals of the factor operation selected by the learner. By placing the bottom left corner or the foldable sheet 703 at the bottom left corner of the question grid 801, the foldable sheet can be folded along the perforated column edge 711 on the right side of the foldable sheet 703 in order to transform its shape to align with the numerals in the numbered tracks 802 along each question grid axis.

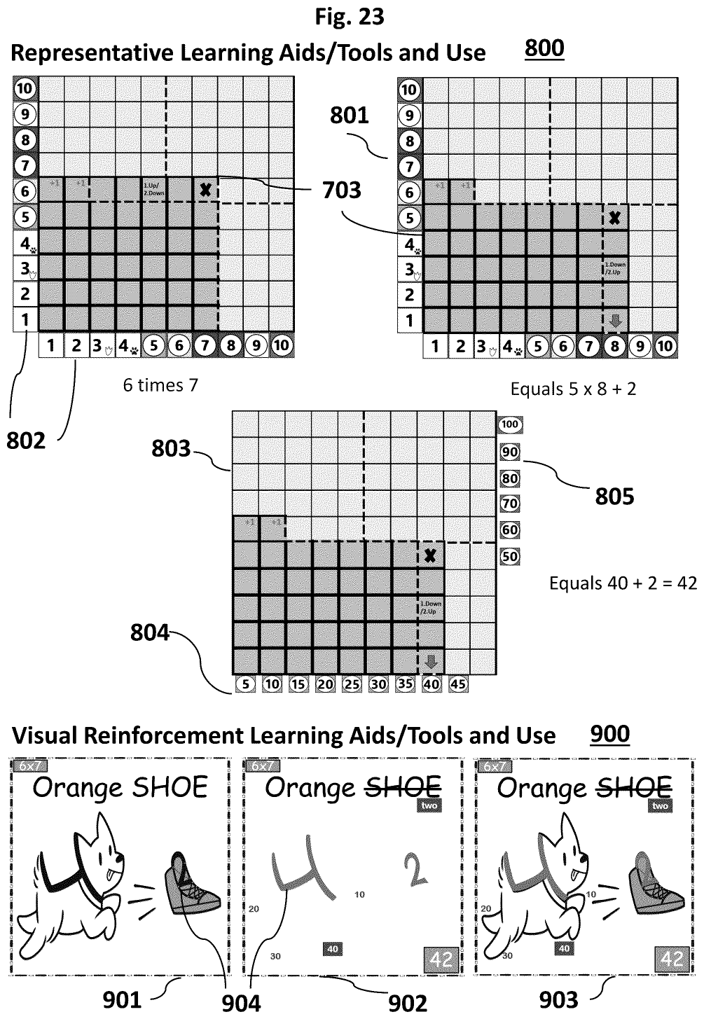

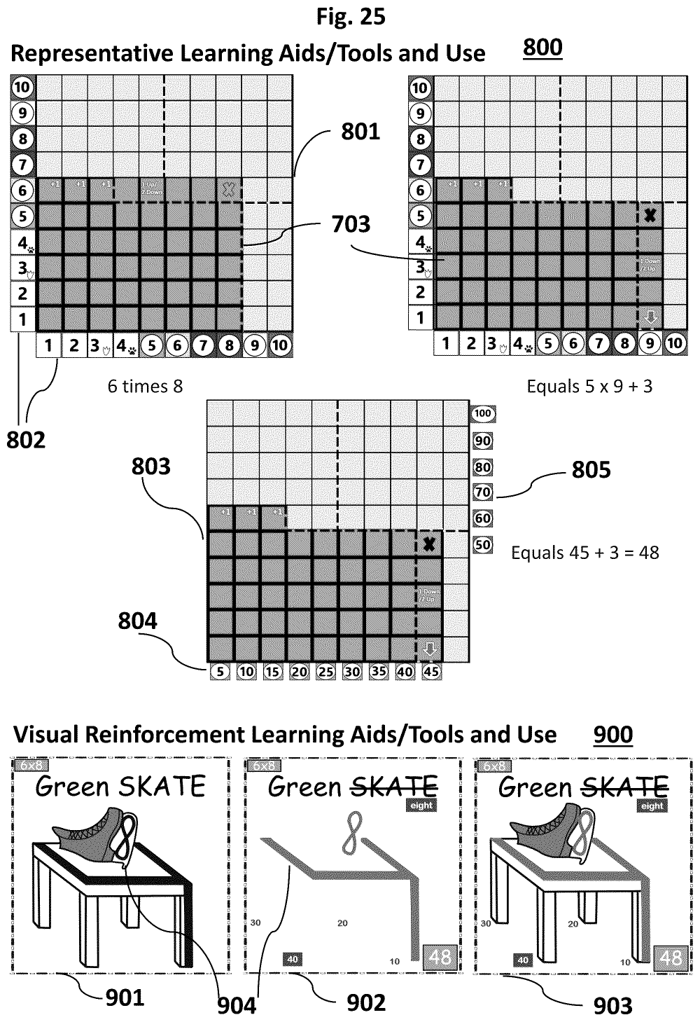

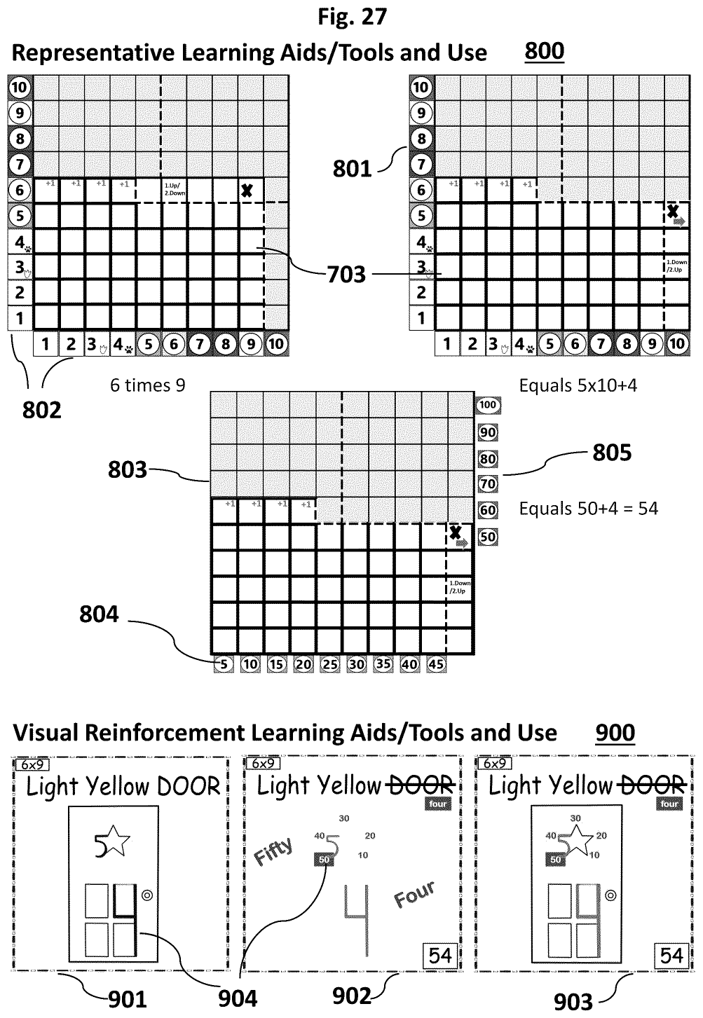

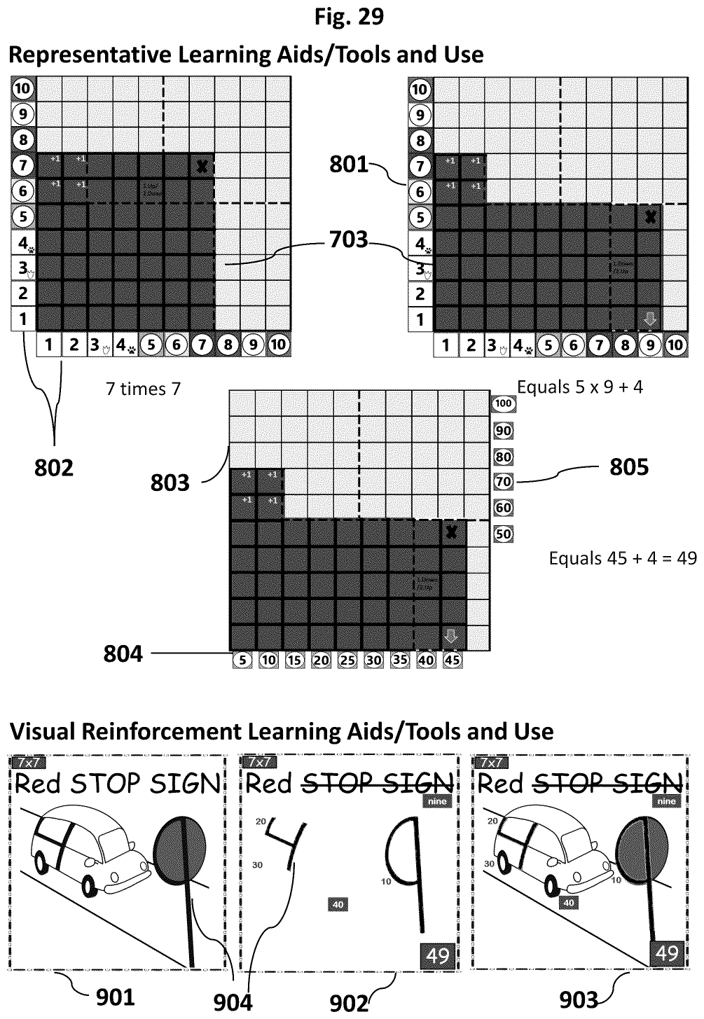

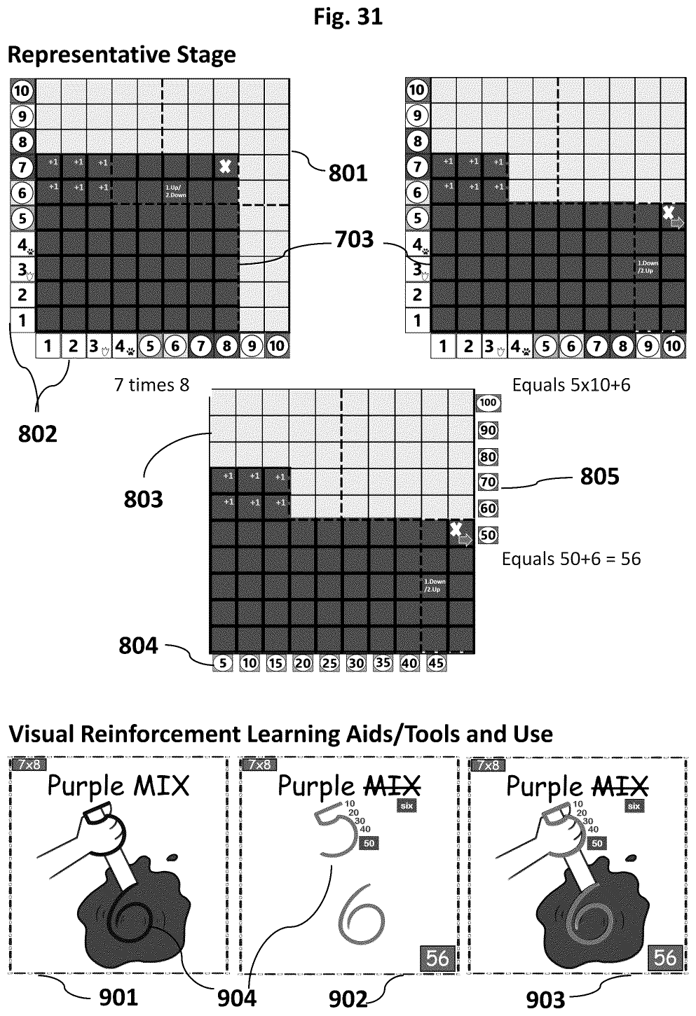

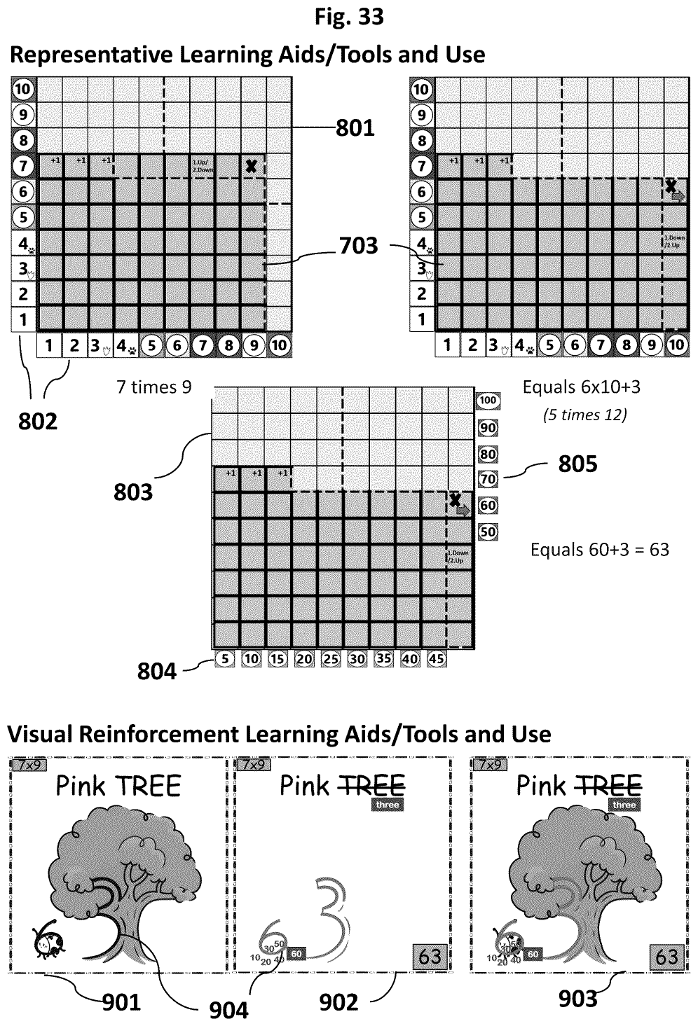

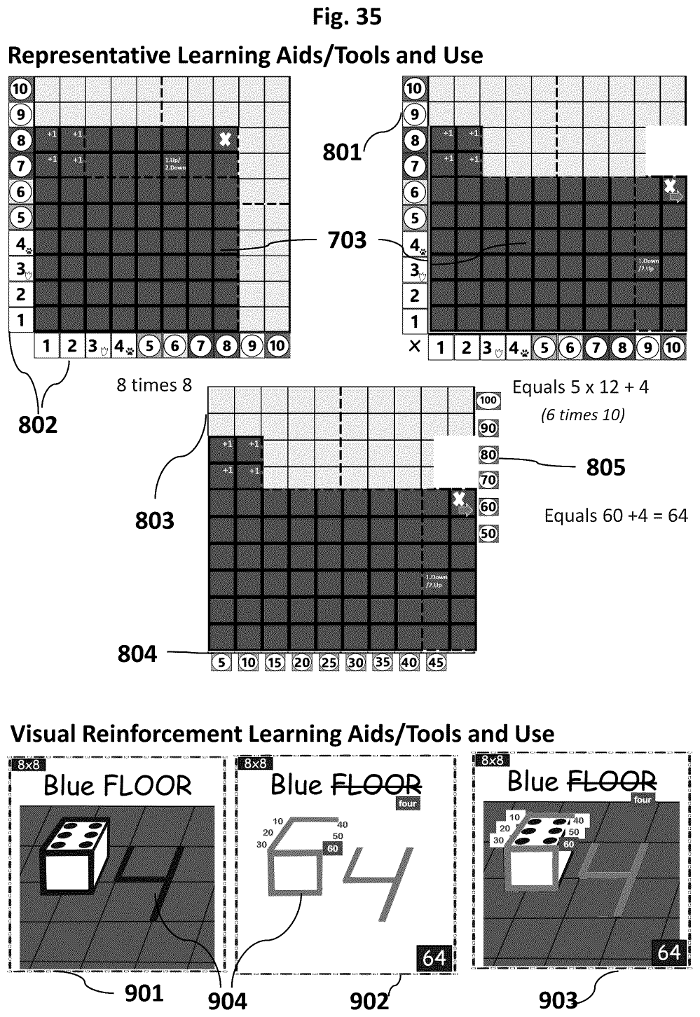

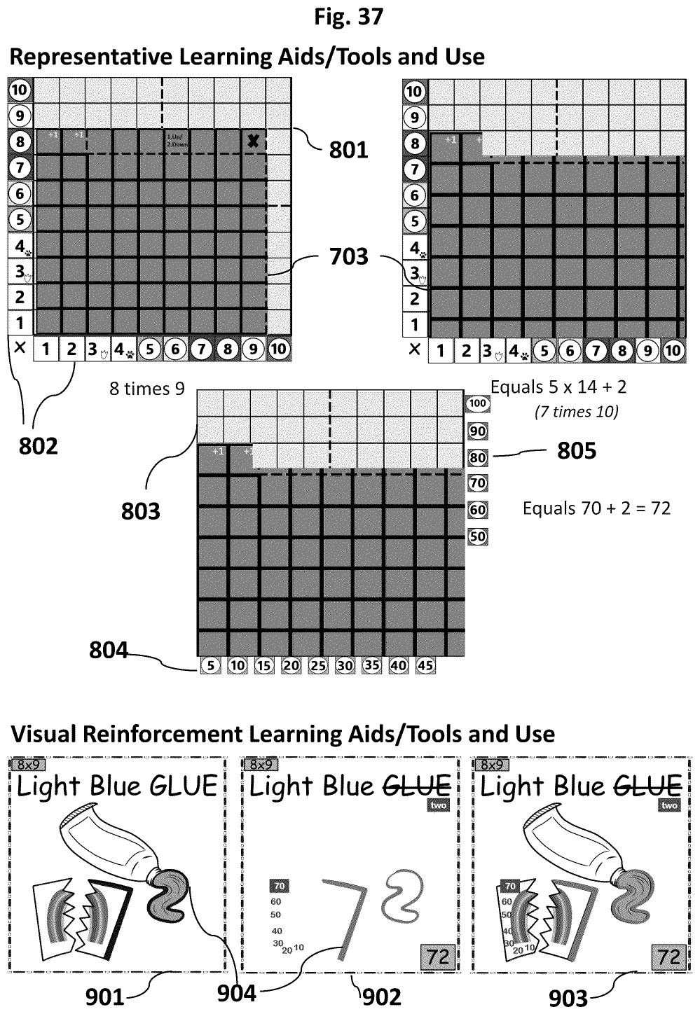

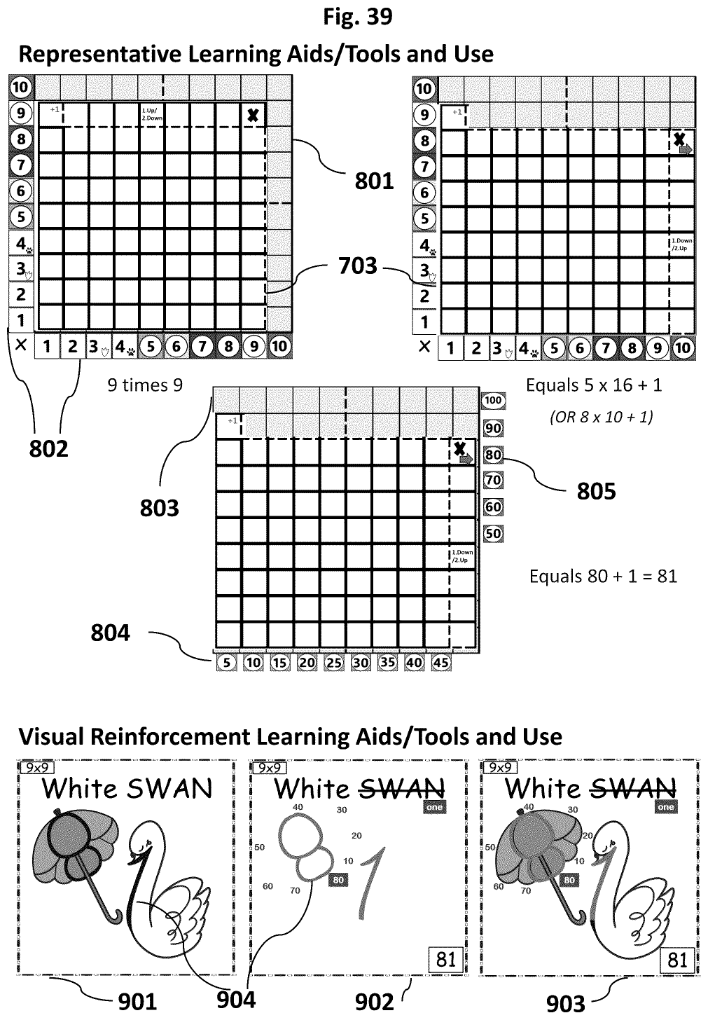

For example, in FIG. 21 the right side column of the yellow foldable sheet 703 is firstly folded under the sheet 703 so that the sheet 703 then aligns with the numerals 6 and 6 along the ‘y’ and ‘x’ axes, respectively, of the numbered tracks 802, to display the number of squares in the firstly folded sheet 703 that correspond in total to the solution of the factor operation 6×6. In FIG. 23, the right side column of the orange foldable sheet 703 is firstly folded under the sheet 703 so that the sheet 703 then aligns with the numerals 6 and 7 along the ‘y’ and ‘x’ axes, respectively, of the numbered tracks 802, to display the number of squares in the firstly folded sheet 703 that correspond in total to the solution of the factor operation 6×7. In FIG. 25, the right side column of the green foldable sheet 703 is firstly folded under the sheet 703 so that the sheet 703 then aligns with the numerals 6 and 8 along the ‘y’ and ‘x’ axes, respectively, of the numbered tracks 802, to display the number of squares in the firstly folded sheet 703 that correspond in total to the solution of the factor operation 6×8. In FIG. 27, the right side column of the light yellow foldable sheet 703 is firstly folded under the sheet 703 so that the sheet 703 then aligns with the numerals 6 and 9 along the ‘y’ and ‘x’ axes, respectively, of the numbered tracks 802, to display the number of squares in the firstly folded sheet 703 that correspond in total to the solution of the factor operation 6×9. In FIG. 29, the right side columns of the red foldable sheet 703 are firstly folded under the sheet 703 so that the sheet 703 then aligns with the numerals 7 and 7 along the ‘y’ and ‘x’ axes, respectively, of the numbered tracks 802, to display the number of squares in the firstly folded sheet 703 that correspond in total to the solution of the factor operation 7×7. In FIG. 31, the right side columns of the purple foldable sheet 703 are firstly folded under the sheet 703 so that the sheet 703 then aligns with the numerals 7 and 8 along the ‘y’ and ‘x’ axes, respectively, of the numbered tracks 802, to display the number of squares in the firstly folded sheet 703 that correspond in total to the solution of the factor operation 7×8. In FIG. 33, the right side column of the pink foldable sheet 703 is firstly folded under the sheet 703 so that the sheet 703 then aligns with the numerals 7 and 9 along the ‘y’ and ‘x’ axes, respectively, of the numbered tracks 802, to display the number of squares in the firstly folded sheet 703 that correspond in total to the solution of the factor operation 7×9. In FIG. 35, the right side column of the blue foldable sheet 703 is firstly folded under the sheet 703 so that the sheet 703 then aligns with the numerals 8 and 8 along the ‘y’ and ‘x’ axes, respectively, of the numbered tracks 802, to display the number of squares in the firstly folded sheet 703 that correspond in total to the solution of the factor operation 8×8 In FIG. 37, the right side columns of the light blue foldable sheet 703 are firstly folded under the sheet 703 so that the sheet 703 then aligns with the numerals 8 and 9 along the ‘y’ and ‘x’ axes, respectively, of the numbered tracks 802, to display the number of squares in the firstly folded sheet 703 that correspond in total to the solution of the factor operation 8×9. In FIG. 39, the right side column of the white foldable sheet 703 is firstly folded under the sheet 703 so that the sheet 703 then aligns with the numerals 9 and 9 along the ‘y’ and ‘x’ axes, respectively, of the numbered tracks 802, to display the number of squares in the firstly folded sheet 703 that correspond in total to the solution of the factor operation 9×9.

Once a firstly folded sheet 703 is aligned as described above on a question grid 801 it can be further manipulated by unfolding the right folder column(s) of the firstly folded sheet 703 along the perforated edge 711. The sheet 703 can then be folded along the perforated row edge 712 near the top of foldable sheet 703 in order to transform its shape to align with the numerals in the numbered tracks 802 along each axis of the question grid 801 to reveal a 5 times factor operation and an addition operation that can be recorded as an equation generally represented as “5×+y” or in some cases as “10×+y”. The 5 times or 10 times factor operation (5× or 10×) is characterized by the alignment of the quadrilateral portion of the secondly folded sheet 703 with the numerals of the numbered tracks 802. The addition operation (+y) to the 5× or 10×product is characterized by the number of squares of the secondly folded sheet 703 remaining outside of the quadrilateral portion of said secondly folded sheet 703. The total number of squares revealed by the secondly folded sheet 703 configuration remains equal to the numeric solution of the original factor operation selected by the learner.

For example, with reference to FIG. 21, the folded rights side column of the firstly folded sheet 703 is unfolded and a portion of the top row is secondly folded under the sheet 703 such that the quadrilateral portion of the sheet 703 aligns with the numerals 5 and 7 of the ‘x’ and ‘y's axes, respectively, and the number of squares (units) remaining outside of the quadrilateral portion of the secondly folded sheet 703 is 1 to provide the equation “5×7+1”. In FIG. 23, the folded rights side column of the firstly folded sheet 703 is unfolded and a portion of the top row is secondly folded under the sheet 703 such that the quadrilateral portion of the sheet 703 aligns with the numerals 5 and 8 of the ‘x’ and ‘y’s axes, respectively, and the number of squares remaining outside of the quadrilateral portion of the secondly folded sheet 703 is 2 to provide the equation “5×8+2”. In FIG. 25, the folded right side column of the firstly folded sheet 703 is unfolded and a portion of the top row is secondly folded under the sheet 703 such that the quadrilateral portion of the sheet 703 aligns with the numerals 5 and 9 of the ‘x’ and ‘y's axes, respectively, and the number of squares remaining outside of the quadrilateral portion of the secondly folded sheet 703 is 3 to provide the equation “5×9+3”. In FIG. 27, the folded right side column of the firstly folded sheet 703 is unfolded and a portion of the top row is secondly folded under the sheet 703 such that the quadrilateral portion of the sheet 703 aligns with the numerals 5 and 10 of the ‘x’ and ‘y's axes, respectively, and the number of squares remaining outside of the quadrilateral portion of the secondly folded sheet 703 is 4 to provide the equation “5×10+4”. In FIG. 29, the folded right side columns of the firstly folded sheet 703 are unfolded and a portion of the two top rows are secondly folded under the sheet 703 such that the quadrilateral portion of the sheet 703 aligns with the numerals 5 and 9 of the ‘x’ and ‘y's axes, respectively, and the number of squares remaining outside of the quadrilateral portion of the secondly folded sheet 703 is 4 to provide the equation “5×9+4”. In FIG. 31, the folded right side columns of the firstly folded sheet 703 are unfolded and a portion of the two top rows are secondly folded under the sheet 703 such that the quadrilateral portion of the sheet 703 aligns with the numerals 5 and 10 of the ‘x’ and ‘y's axes, respectively, and the number of squares remaining outside of the quadrilateral portion of the secondly folded sheet 703 is 6 to provide the equation “5×10+6”. In FIG. 33, the folded right side column of the firstly folded sheet 703 is unfolded and a portion of the top row is secondly folded under the sheet 703 such that the quadrilateral portion of the sheet 703 aligns with the numerals 6 and 10 of the ‘x’ and ‘y's axes, respectively, and the number of squares remaining outside of the quadrilateral portion of the secondly folded sheet 703 is 3 to provide the equation “6×10+3”. In FIG. 35, the folded right side columns of the firstly folded sheet 703 are unfolded and a portion of the two top rows are secondly folded under the sheet 703 such that the quadrilateral portion of the sheet 703 aligns with the numerals 6 and 10 of the ‘x’ and ‘y's axes, respectively, and the number of squares remaining outside of the quadrilateral portion of the secondly folded sheet 703 is 4 to provide the equation “6×10+4”. In FIG. 37, the folded right side column of the firstly folded sheet 703 is unfolded and a portion of the top row is secondly folded under the sheet 703 such that the quadrilateral portion of the sheet 703 aligns with the numerals 7 and 10 of the ‘x’ and ‘y's axes, respectively, and the number of squares remaining outside of the quadrilateral portion of the secondly folded sheet 703 is 2 to provide the equation “7×10+2”. In FIG. 39, the folded right side column of the firstly folded sheet 703 is unfolded and a portion of the top row is secondly folded under the sheet 703 such that the quadrilateral portion of the sheet 703 aligns with the numerals 8 and 10 of the ‘x’ and ‘y's axes, respectively, and the number of squares remaining outside of the quadrilateral portion of the secondly folded sheet 703 is 1 to provide the equation “8×10+1”.

Besides being able to count the number of squares in the firstly and secondly folded sheets 703, the learner is also able to discover the solution (product) to the selected factor operation(s) by transposing the secondly folded sheets to the answer grid 803. Notable features of the answer grid 803 is the ‘x’ axis which is numbered from left to right in increments of 5 (as a track 804 from 5 to 45) and the ‘y’ axis that is numbered in increments of 10 (as a track 805 from 50 to 100). By placing the secondly folded sheet 703 on the answer (solution) grid 803, again aligning the bottom left corner of the sheet 703 to the bottom left corner of the grid 803, the solution of the selected factor operation(s) is/are revealed. For example, in FIG. 21, the product of the 5 times operation is indicated by an arrow 709 pointing to the numeral 35 of the track 804 and with the addition of 1 square to this product reveals the solution 36 to the factor operation 6×6. In FIG. 23, the product of the 5 times operation is indicated by an arrow 709 pointing to the numeral 40 of the track 804 and with the addition of 2 squares to this product reveals the solution 42 to the factor operation 6×7. In FIG. 25, the product of the 5 times operation is indicated by an arrow pointing to the numeral 45 of the track 804 and with the addition of 3 squares to this product reveals the solution 48 to the factor operation 6×8. In FIG. 27, the product of the 5 times operation is indicated by an arrow 709 pointing to the numeral 50 of the track 805 and with the addition of 4 squares to this product reveals the solution 54 to the factor operation 6×9. In FIG. 29, the product of the 5 times operation is indicated by an arrow 709 pointing to the numeral 45 of the track 804 and with the addition of 4 squares to this product reveals the solution 49 to the factor operation 7×7. In FIG. 31, the product of the 5 times operation is indicated by an arrow 709 pointing to the numeral 50 of the track 805 and with the addition of 6 squares to this product reveals the solution 56 to the factor operation 7×8. In FIG. 33, the product of the 5 times operation is indicated by an arrow 709 pointing to the numeral 60 of the track 805 and with the addition of 3 squares to this product reveals the solution 63 to the factor operation 7×9. In FIG. 35, the product of the 5 times operation is indicated by an arrow 709 pointing to the numeral 60 of the track 805 and with the addition of 4 squares to this product reveals the solution 64 to the factor operation 8×8. In FIG. 37, the product of the 5 times operation is indicated by an arrow 709 pointing to the numeral 70 of the track 805 and with the addition of 2 squares to this product reveals the solution 72 to the factor operation 8×9. In FIG. 39, the product of the 5 times operation is indicated by an arrow 709 pointing to the numeral 80 of the track 805 and with the addition of 1 square to this product reveals the solution 81 to the factor operation 9×9.

### Manipulative (Grouping) Learning Aids

To provide a further (optional) opportunity for learners to use tactile (hands on) manipulation processes to discover the solutions to factor operations according to the disclosure, sets of learning aids 700 are provided as shown in FIGS. 20, 22, 24, 26, 28, 30, 32, 34, 36 and 38. These sets of learning aids may be used in conjunction with the corresponding sets of foldable (representative) learning aids (See FIGS. 21, 23, 25, 27, 29, 31, 33, 35, 37 and 39) by virtue of the foldable sheets being amenable to being transformed into a quadrilateral form equivalent in size, colour and total number of unit squares to the quadrilateral sheets of illustrated in FIGS. 20, 22, 24, 26, 28, 30, 32, 34, 36 and 38. In one embodiment the manipulative grouping learning aids are used by a learner prior to using the representative learning aids described above.

More particularly, the optional sets of learning aids 700 each comprise a quadrilateral grid sheet 704 having the same colour as the foldable sheet 703, and the colour being of a given factor operation representation 50. Two factor bars 702 are provided for each quadrilateral grid sheet 704, each with a number of squares corresponding to a numeric factor of a selected factor operation in respect of which the solution is to be discovered. Each factor bar 702 is coloured in the primary colour associated with the numeric factor on the die faces, or in accordance with FIG. 1. Also included with each quadrilateral grid sheet 704 are a group of 5-square pieces (mostly bars) 705 coloured in a non-primary colour and used to discover the equations described above comprising a 5 times factor operation and addition operation. These equations are revealed by grouping the squares of each quadrilateral grid sheet 704 using a pre-set or predetermined number of 5-square pieces to provide a 5 times factor operation (corresponding to a “5×” product) and counting the remaining ungrouped or uncovered squares of each respective quadrilateral grid sheet 704 to provide the “y” value added to the “5×” product to discover the solution of the selected factor operation. These steps mimic or follow a similar approach of making a secondly folded sheet 703 that is subsequently placed onto an answer grid 803 to obtain a given “5×+y” equation and thereby discover the solution to the selected factor operation. It is to be understood that in some cases it may be the preference of a learner to discover a “10×+y” equation as illustrated using the representative learning aids previously and accordingly 10-square pieces can also be provided as additional or alternative manipulative grouping aids within a set of such aids.

After selecting a factor operation, a learner selects the quadrilateral grid sheet 704 corresponding to the colour of the factor operation representation 50. The learner then selects the first factor bar 702 corresponding to the first factor of the selected factor operation and aligns it along the left edge of the quadrilateral grid sheet 804 (‘y’ axis). The second factor bar 702 corresponding to the second factor of the selected factor operation is aligned along the bottom edge of the quadrilateral sheet 804. This arrangement of learning aids mimics the placement of a firstly folded sheet 703 on a question grid 801. The learner may than overlay the group of 5-square bars 705 provided with a given quadrilateral grid sheet 704 to partially (but mostly) cover the quadrilateral grid sheet 704 and reveal a 5 times factor operation and addition operation representation 706, wherein the total number of 5-square pieces 705 (mostly in form of 5 square bars) represents the 5 times operation and the total number of exposed (uncovered) squares from the underlying quadrilateral grid sheet 704 provides the value for the addition to the product of the 5 times operation, generally expressed by the equation “5×+y”.

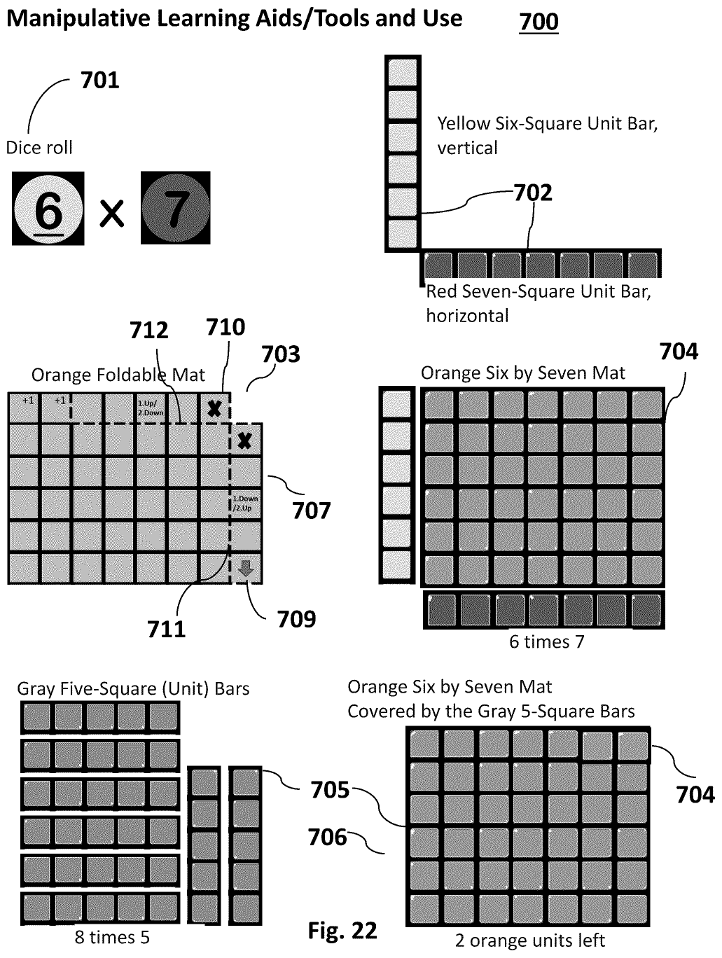

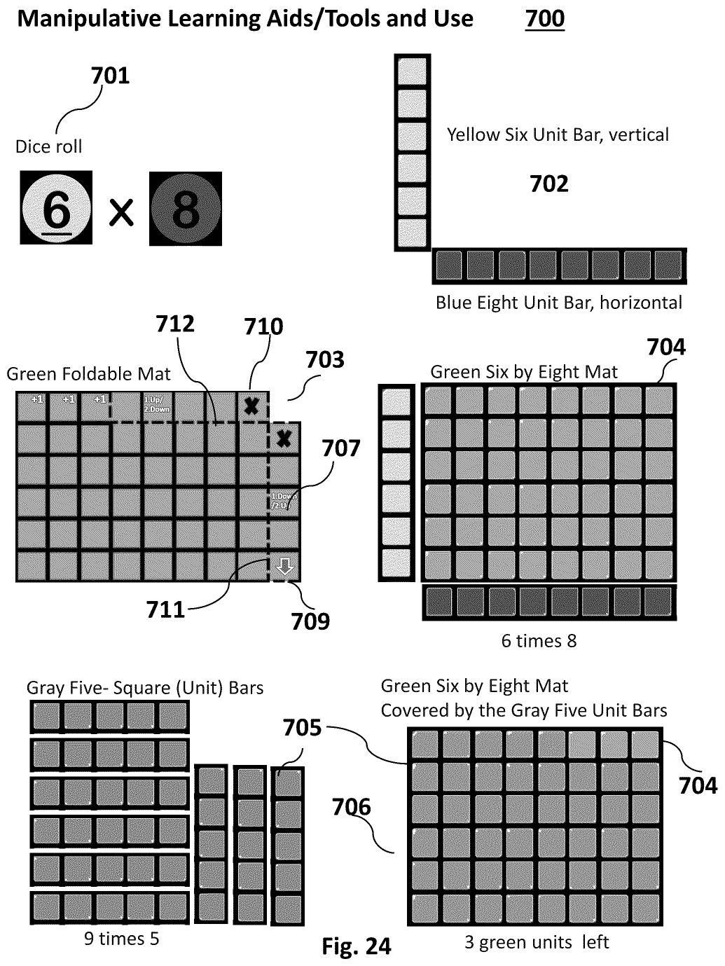

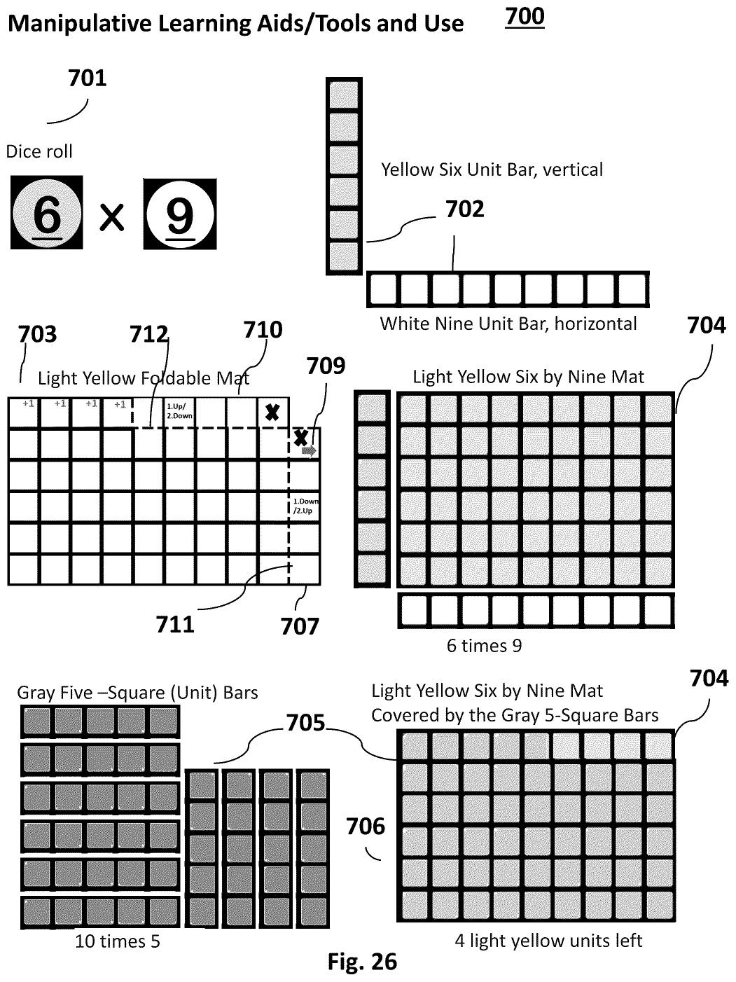

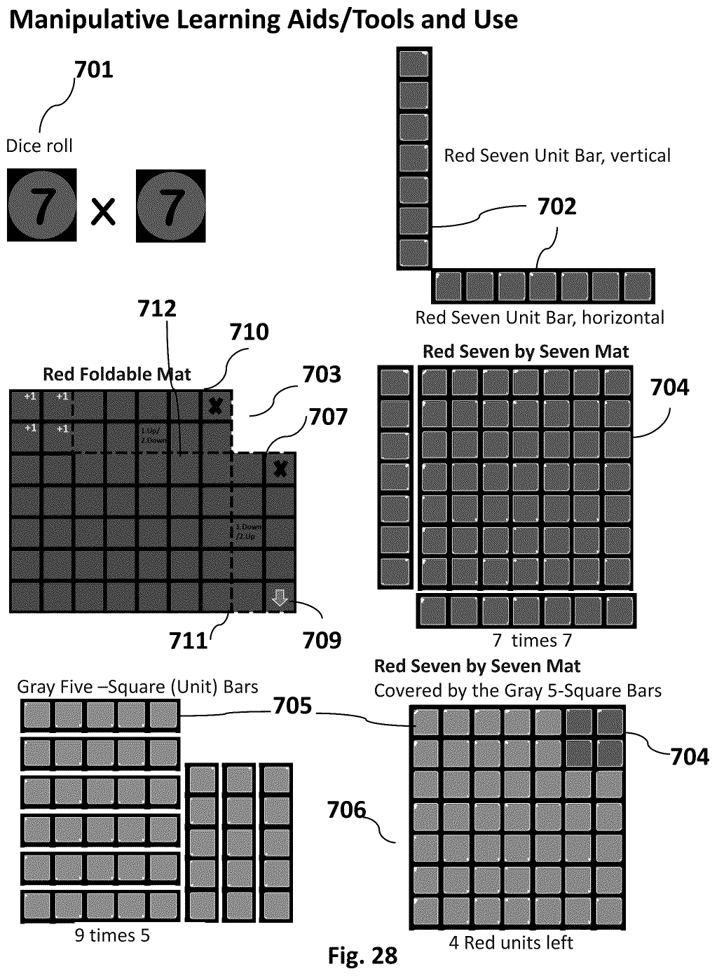

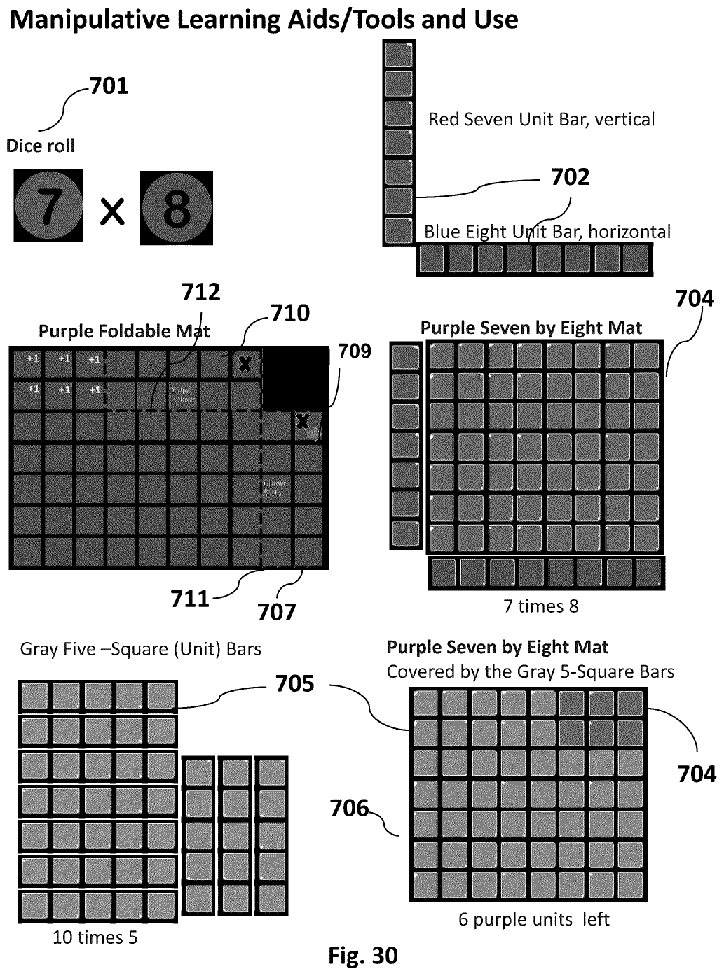

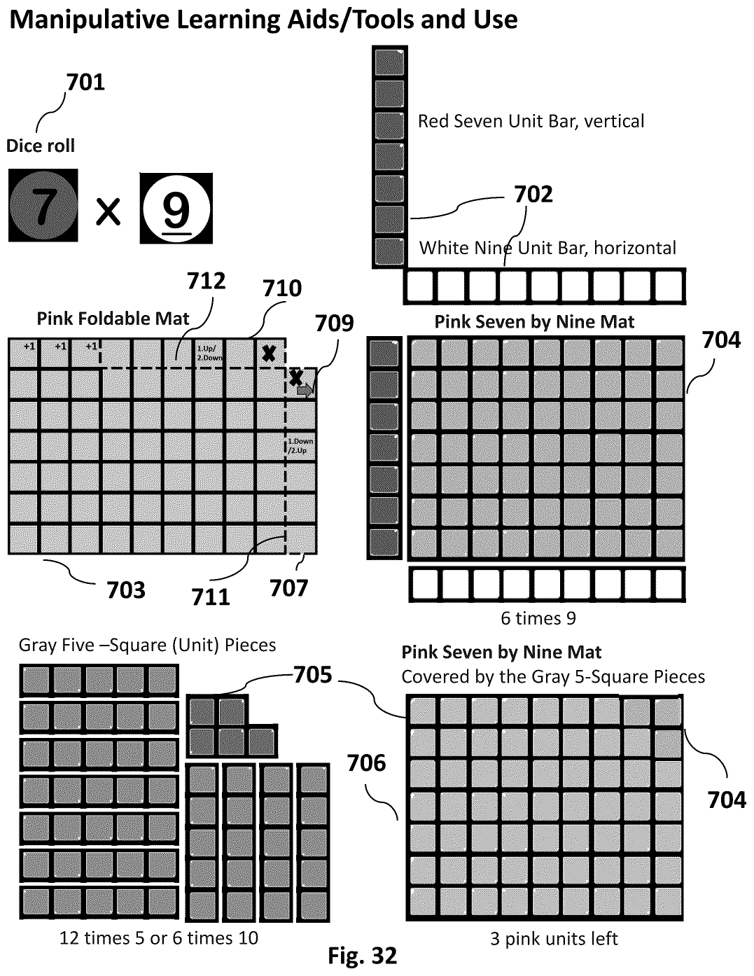

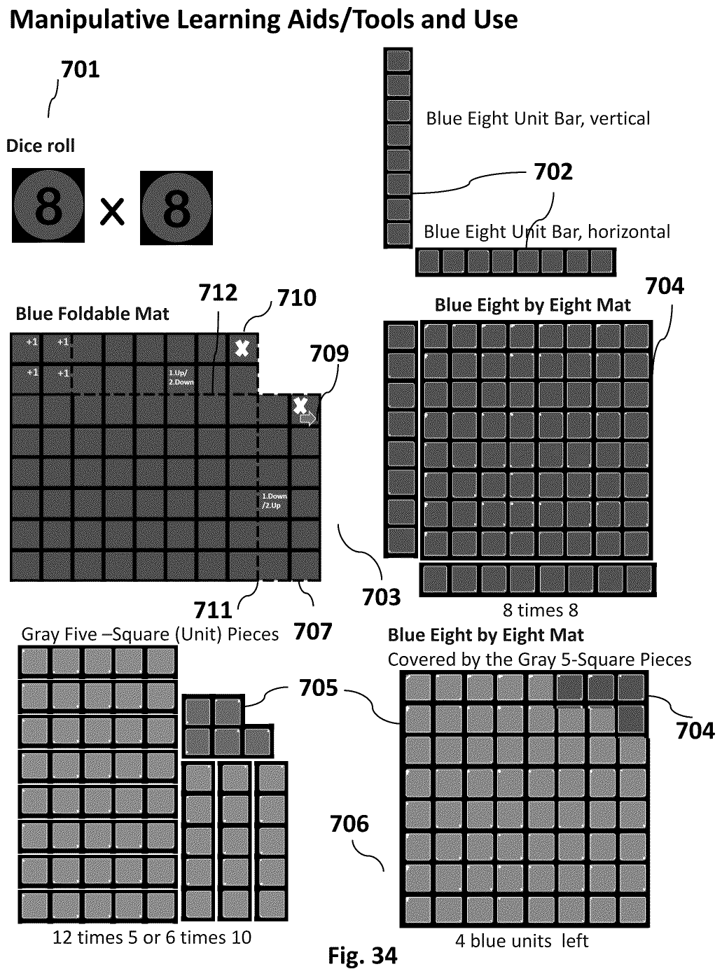

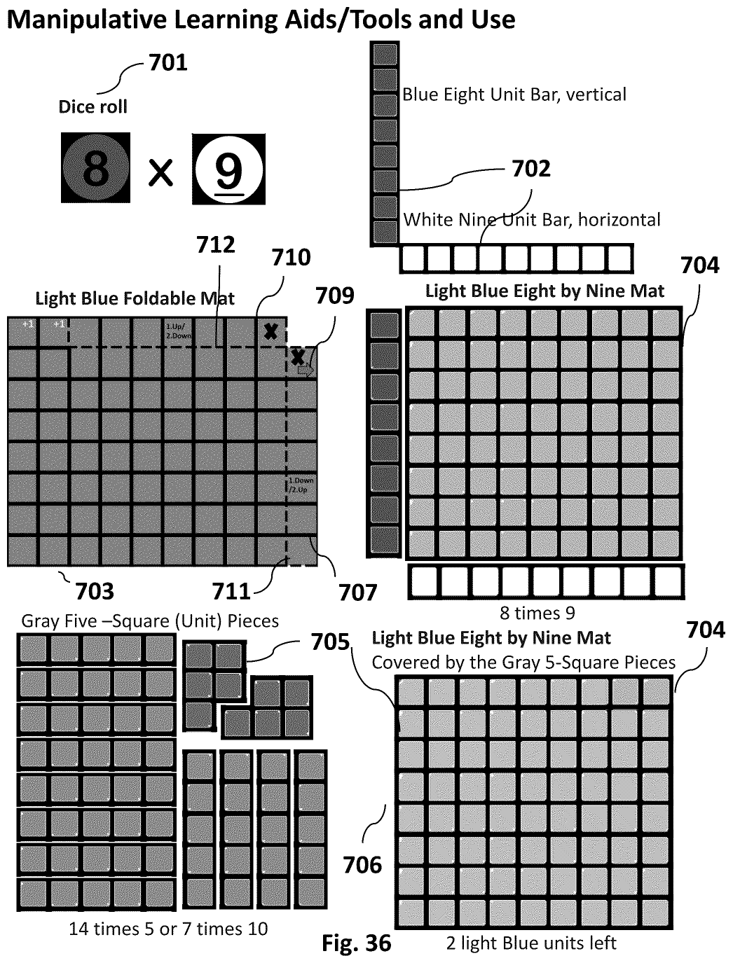

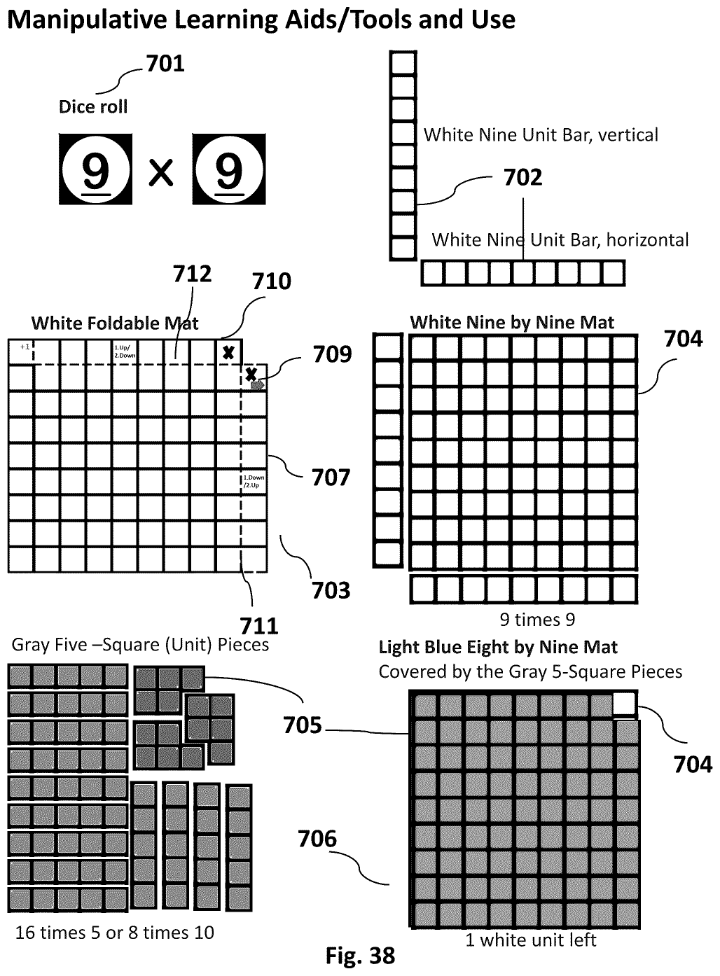

For example, in FIG. 20 a set of manipulative learning aids for revealing the solution of the “5×+y” equation that is same as the solution of the 6×6 factor operation is provided. In FIG. 22, a set of manipulative learning aids for revealing the solution of the “5×+y” equation that is same as the solution of the 6×7 factor operation is provided. In FIG. 24, a set of manipulative learning aids for revealing the solution of the “5×+y” equation that is same as the solution of the 6×8 factor operation is provided. In FIG. 26, a set of manipulative learning aids for revealing the solution of the “5×+y” equation that is same as the solution of the 6×9 factor operation is provided. In FIG. 28, a set of manipulative learning aids for revealing the solution of the “5×+y” equation that is same as the solution of the 7×7 factor operation is provided. In FIG. 30, a set of manipulative learning aids for revealing the solution of the “5×+y” equation that is same as the solution of the 7×8 factor operation is provided. In FIG. 32, a set of manipulative learning aids for revealing the solution of the “5×+y” equation that is same as the solution of the 7×9 factor operation is provided. In FIG. 34, a set of manipulative learning aids for revealing the solution of the “5×+y” equation that is same as the solution of the 8×8 factor operation is provided. In FIG. 36, a set of manipulative learning aids for revealing the solution of the “5×+y” equation that is same as the solution of the 8×9 factor operation is provided. In FIG. 38, a set of manipulative learning aids for revealing the solution of the “5×+y” equation that is same as the solution of the 9×9 factor operation is provided.

### Visual Reinforcement Learning Aids

FIGS. 21, 23, 25, 27, 29, 31, 33, 35, 37 and 39 each illustrate optional image sheet and image laminate pairings that can form part of the exemplary kit of this Example 3 as sets of learning aids 900. These aids provide a pathway for the learner to discover the numerical solutions of factor operations when presented with solution representations 60 as shown in FIG. 19. For each factor operation selected, e.g. obtained using the dice 602, there is a solution representation sheet provided with the kit. Each solution representation 60 depicted on a sheet 901 has embedded in it the outline of the numeric solution (product) 904 of the solution representation 60 it corresponds to. By overlaying onto a solution representation sheet 901 the corresponding transparency (laminate) 902 with the numeric solution 904 printed on it, the learner both discovers the solution for a given factor operation and is able to recognize the presence of the numeric solution 904 in the imagery of the solution representation sheet 901 as well. With reference to each of FIGS. 21, 23, 25, 27, 29, 31, 33, 35, 37 and 39, when a laminate 902 is overlaid over solution representation sheet 901 a combined sheet and laminate pairing 903 helps make the numeric solution 904 stand out visually for the learner to see and discover.

More particularly, in FIG. 21, the image embedded numeric solution 904 of the solution representation sheet 901, also printed on the corresponding laminate 902 for said solution representation sheet 901, with the title attribute “Yellow CHICKS”, is 36, as displayed by the combined sheet/laminate pairing 903. In FIG. 23, the image embedded numeric solution 904 of the solution representation sheet 901, also printed on the corresponding laminate 902 for said solution representation sheet 901, with the title attribute “Orange SHOE”, is 42, as displayed by the combined sheet/laminate pairing 903. In FIG. 25, the image embedded numeric solution 904 of the solution representation sheet 901, also printed on the corresponding laminate 902 for said solution representation sheet 901, with the title attribute “Green SKATE”, is 48, as displayed by the combined sheet/laminate pairing 903. In FIG. 27, the image embedded numeric solution 904 of the solution representation sheet 901, also printed on the corresponding laminate 902 for said solution representation sheet 901, with the title attribute “Light Yellow DOOR”, is 54, as displayed by the combined sheet/laminate pairing 903. In FIG. 29, the image embedded numeric solution 904 of the solution representation sheet 901, also printed on the corresponding laminate 902 for said solution representation sheet 901, with the title attribute “Red STOP SIGN”, is 49, as displayed by the combined sheet/laminate pairing 903. In FIG. 31, the image embedded numeric solution 904 of the solution representation sheet 901, also printed on the corresponding laminate 902 for said solution representation sheet 901, with the title attribute “Purple MIX”, is 56, as displayed by the combined sheet/laminate pairing 903. In FIG. 33, the image embedded numeric solution 904 of the solution representation sheet 901, also printed on the corresponding laminate 902 for said solution representation sheet 901, with the title attribute “Light Blue GLUE”, is 72, as displayed by the combined sheet/laminate pairing 903. In FIG. 35, the image embedded numeric solution 904 of the solution representation sheet 901, also printed on the corresponding laminate 902 for said solution representation sheet 901, with the title attribute “Blue FLOOR”, is 84, as displayed by the combined sheet/laminate pairing 903. In FIG. 37, the image embedded numeric solution 904 of the solution representation sheet 901, also printed on the corresponding laminate 902 for said solution representation sheet 901, with the title attribute “Pink TREE”, is 63, as displayed by the combined sheet/laminate pairing 903. In FIG. 39, the image embedded numeric solution 904 of the solution representation sheet 901, also printed on the corresponding laminate 902 for said solution representation sheet 901, with the title attribute “White SWAN”, is 81, as displayed by the combined sheet/laminate pairing 903.

The invention has many different features, variations and multiple different embodiments. The invention has been described in this application at times in terms of specific embodiments for illustrative purposes and without the intent to limit or suggest that the invention conceived is only one particular embodiment. It is to be understood that the invention is not limited to any single specific embodiments or enumerated variations. Many modifications, variations and other embodiments of the invention will come to mind of those skilled in the art to which this invention pertains, and which are intended to be and are covered by both this disclosure. It is indeed intended that the scope of the invention should be determined by proper interpretation and construction of the disclosure, including equivalents, as understood by those of skill in the art relying upon the complete disclosure at the time of filing.

The disclosures of all patents, patent applications, publications and database entries referenced in this specification are hereby specifically incorporated by reference in their entirety to the same extent as if each such individual patent, patent application, publication and database entry were specifically and individually indicated to be incorporated by reference.

Although the invention has been described with reference to certain specific embodiments, various modifications thereof will be apparent to those skilled in the art without departing from the spirit and scope of the invention. All such modifications as would be apparent to one skilled in the art are intended to be included within the scope of the following claims.

1. A multi-piece semi-circle and track set of learning aids for discovering the solution of a multiplication operation comprising:
a) a first piece provided in a physical or a digital format comprising a multi-layered first piece with a numbered track portion and a first piece semi-circular portion, displaying in segments of a first outermost layer of said portion from left to right, a series of products each corresponding to a solution of a two factor operation consisting of factors selected from the numerals 6 to 9 and a numbered track portion under the first piece semi-circular portion displaying the numerals 3 to 12;
b) a second piece provided in a physical or a digital format comprising a multi-layered second piece semi-circular portion, displaying, in segments of a second outermost layer of said portion from left to right, an array of colours, and, in segments of an inner layer immediately under the second outermost layer from left to right, a series of solution representations each comprising the colour above it in the second outermost layer, wherein when the second piece is overlaid over the first piece the array of colours displayed in the second outermost layer covers the series of products displayed in the first outermost layer;
c) a third piece provided in a physical or a digital format comprising a multi-layered third piece semi-circular portion, displaying, in segments of a third outermost layer of said portion from left to right, the same array of colours as the array of colours displayed in the second outermost layer and, in segments of an inner layer immediately under the third outermost layer form left to right, a series of two factor operations consisting of factors selected from the numerals 6 to 9, wherein the colour above each two factor operation is a factor operation representation colour and the same colour displayed in the second outermost layer of the second piece that covers the product displayed in the first outermost layer, such that when the third piece is overlaid over the second piece, the array of colours displayed in the third outermost layer covers the series of solution representations displayed in the inner layer of the second piece; and
d) a fourth piece provided in a physical or a digital format comprising a multi-layered fourth piece semi-circular portion, displaying, in segments of a third outermost layer of said portion from left to right, the same array of colours as the array of colours displayed in the third outermost layer and in the second outermost layer, wherein when the fourth piece is overlaid over the third piece, the array of colours in the fourth outermost layer covers the series of factor operations displayed in the inner layer of the third piece;
wherein overlaying the second piece over the first piece, the third piece over the second piece and the fourth piece over the third piece provides an assembled multi-piece semi-circle and track tool combining the semi-circular portions of each of said pieces to provide an array of combined segments each including the alignment of like coloured segments displayed in each of the second, third and fourth outermost layers, respectively, for a user to disassemble and discover the solution of a user-selected two factor operation consisting of factors selected from the numerals 6 to 9.

2. A method of solving a multiplication operation comprising the steps of:
a) providing a set of learning aids according to claim 1;
b) assembling the set of learning aids to provide the multi-piece semi-circle and track tool;
c) selecting a combined coloured segment from the combined semi-circular portions of multi-piece semi-circle and track tool to select a factor operation representation colour;
d) removing the fourth piece from on top of the third piece to reveal the user-selected two factor operation displayed in the inner layer of the third piece under the selected factor operation representation colour displayed in the fourth outermost layer of the fourth piece, in the same combined segment of the tool;
e) removing the third piece from on top of the second piece to reveal the solution representation displayed in the inner layer of the second piece under the selected factor operation representation colour displayed in the third outermost layer of the third piece, in the same combined segment also containing the user-selected two factor operation revealed in step (d); and
f) removing the second piece from on top of the first piece to reveal the product of the user-selected two factor operation displayed in the first outermost layer of the first piece under the selected factor operation representation colour displayed in the second outermost layer of the second piece, in same combined segment of the tool also containing the user-selected two factor operation revealed in step (d) and the solution representation revealed in step (e).

3. A kit for a user to solve a multiplication operation comprising the learning aids of claim 1.

4. The kit of claim 3, also comprising a colour mixed reference tool.

5. The kit of claim 4, wherein the colour mixed reference tool comprises a sixteen square grid constructed of and fixed onto media, with a first set of numeral and colour pairings arranged along a horizontal axis of the grid, and a second set of numeral and colour pairings arranged along a vertical axis of the grid, each set of pairings consisting of a numeral 6 and yellow colour pairing, a numeral 7 and red colour pairing, a numeral 8 and blue colour pairing, and a numeral 9 and white colour pairing.

6. The kit of claim 5, wherein the user constructs the colour mixed reference tool by performing one or more colour mixing operations using the media to: (i) mix a colour in a pairing along the horizontal axis with a colour in a pairing along the vertical axis to obtain a mixed colour, and ii) colour a square of the grid located at an intersection of a column of the grid aligned with the pairing along the horizontal axis and a row of the grid aligned with the pairing along the vertical axis using the mixed colour.

7. The kit of claim 3, also comprising one or more sets of manipulative grouping learning aids, one or more sets of representative learning aids and/or one or more sets of visually reinforcing learning aids to help a user discover the solution of a user-selected two factor operation consisting of factors selected from the numerals 6 to 9.

8. The kit of claim 5, wherein a set of manipulative grouping learning aids comprises tools for solving a user-selected two factor operation consisting of factors selected from the numerals 6 to 9, including: i) a coloured quadrilateral grid sheet with squares totaling in number to the solution of the user-selected two factor operation, wherein the quadrilateral sheet has the same colour as a pre-assigned factor operation representation colour for the user-selected factor operation; ii) two factor bars, each with a number of squares corresponding to a numeric factor of the user-selected factor operation, wherein each of the bars is coloured in a primary, pre-assigned factor representation colour for the respective numeric factor of the user-selected factor operation, and a group of five-square pieces coloured in a non-primary colour, wherein when the group of pieces is overlaid on top of the quadrilateral grid sheet, the user can discover an equation of the general expression “5×+y” to solve and discover the solution to the user-selected factor operation.

9. The kit of claim 5, wherein a set of representative learning aids comprises tools for solving a user-selected two factor operation consisting of factors selected from the numerals 6 to 9, including: i) a coloured foldable grid sheet with squares totaling in number to the solution of the user-selected two factor operation, a foldable edge for folding and unfolding one or more right side columns and a foldable edge for folding and unfolding one or more partial, top end rows of the foldable grid sheet, wherein the foldable grid sheet has the same colour as a pre-assigned factor operation representation colour for the user-selected factor operation; ii) a question grid mat with ‘x’ and ‘y’ axes each numbered from 1 to 10 and onto which the foldable grid sheet can be placed and manipulated along the foldable edges of said sheet for the user to the discover an equation of the general expression “5×+y” to solve the solution to the user-selected factor operation; and iii) an answer grid mat with a ‘x’ axis numbered in increments of 5 from 5 to 45 and a ‘y’ axis with numbered in increments of 10 from 50 to 100, wherein when the one or more right side columns are unfolded and the one more partial, top end rows are folded, and the foldable grid sheet is then placed onto the answer mat, the user can discover the solution to the equation and the solution to user-selected factor operation.

10. The kit of claim 5, wherein a set of visually reinforcing learning aids comprising tools for discovering a numeric solution of a user-selected two factor operation consisting of factors selected from the numerals 6 to 9, including: i) sheet displaying imagery of a solution representation of the user-selected factor operation with a first outline of the numeric solution embedded in the imagery of the solution representation; and ii) a transparent laminate revealing the numeric solution as a second outline of a numeric solution printed and displayed thereon, wherein when the laminate is overlaid over the sheet displaying the imagery of the solution representation, the outline of the numeric solution on the laminate overlays the outline of the numeric solution embedded in the imagery of the solution representation to provide a superimposed, combined image of the first and second outlines of the numeric solutions.

11. The kit according to claim 4 or 7, wherein the sets of learning aids are provided on a board or in a case.
